(19) United States
(12) Patent Application Publication
(10) Pub. No.: US 2017/0053489 A1
(43) Pub. Date: Feb. 23, 2017

(54) SYSTEMS AND METHODS FOR REPORTING PLAYER WINNINGS

(71) Applicant: Gaming Arts, LLC, Las Vegas, NV (US)

(72) Inventors: David Colvin, Las Vegas, NV (US); Eric D. Colvin, Las Vegas, NV (US)

(21) Appl. No.: 14/997,767

(22) Filed: Jan. 18, 2016

Related U.S. Application Data
(60) Provisional application No. 62/206,118, filed on Aug. 17, 2015.

(51) Int. Cl. G07F 17/32

(52) U.S. Cl. CPC G07F 17/3244; G07F 17/3209; G07F 17/3227; G07F 17/3258

(57) ABSTRACT

A system includes a gaming device including a randomization device for randomly selecting house indicia associated with a game of chance, a payment input device for accepting money or credits for the game, and an output device configured to output reports from the gaming device. The system also includes an accounting system coupled to the gaming device and a win meter configured to output a signal representative of an amount of money or credits won by the player. The gaming device is configured to require a player to submit identification and generate a report including the amount of money or credits won by the player upon a determination that a reporting event has occurred.

### BACKGROUND

Embodiments of the present disclosure relate to systems and methods for determining and reporting winnings of players who play games of chance.

Many players of casino games and other games of chance have the possibility of winning large jackpots or prizes. Such jackpots and prizes are typically categorized as taxable income. The Internal Revenue Service (IRS) has promulgated regulations that require casinos and other gaming establishments to record individual prizes won by players that exceed a certain limit for various games of chance such as certain electronic gaming machines (EGMs) which is currently set at $1,200. Casinos and other gaming establishments are required by the IRS to submit a W-2G form that includes the prize amount, the player's name and social security information, and other data to the IRS when the player wins a prize in excess of the IRS limit. Similar forms may be also be required by other regulatory agencies.

In order to facilitate gathering the information for the W-2G form, the player's gaming device typically locks up until a casino employee gathers the required information. The casino employee pays the jackpot or prize by hand generally accompanied by a copy of a W-2G for the player and then unlocks the gaming device to enable the player to continue playing games of chance. A casino employee then submits the finalized W-2G form to the IRS.

These activities relating to the preparation of the W-2G forms may be cumbersome for gaming establishments, significantly increase labor costs and may reduce the amount of time the player can play games of chance on the gaming device. For example, if the player is playing a game of chance with high wager limits (such as a $500 maximum wager slot machine), the player may frequently win jackpots that exceed the IRS limit. Each time the player wins such a jackpot, however, the player will typically be prevented from continuing to play the game until the casino employee fills out the W-2G form. This may frustrate the player and may also reduce revenues to the casino since the period in which the W-2G form is being prepared is a period in which the gaming device is not usable.

### BRIEF SUMMARY

In one embodiment, a system is provided that includes a gaming device including a randomization device configured to randomly select a plurality of house indicia associated with a game of chance, a payment input device configured to accept money or credits for use in the game of chance, an output device configured to output money or credits from the gaming device, and a gaming processor configured to present the game of chance to a player. The system also includes a gaming establishment accounting system, a wagering meter included within the gaming device or the gaming establishment accounting system, and a win meter included within the gaming device or the gaming establishment accounting system. Any wagering meters or win meters for any embodiments may include any suitable device or system that measures wagering or win activity. The wagering meter is configured to determine an amount of money or credits wagered by the player, and the win meter is configured to determine an amount of money or credits won by the player. In any embodiment, the wagering meter or win meter may output a signal or data representative of an amount of money or credits won by the player in any suitable manner which may be utilized by the system. The gaming establishment accounting system is configured to determine a net win amount based on the amount of money or credits wagered by the player and the amount of money or credits won by the player, and generate a report including the net win amount upon a determination that a reporting event has occurred either individually or in the aggregate. Additional information may be included in the report such as a player's name, player's address, player's phone number, player's social security number, gaming establishment's name, gaming establishment's address, gaming establishment's phone number, gaming establishment's employer identification number (EIN), etc. Further, any or all information may be encrypted for security purposes.

### BRIEF DESCRIPTION OF THE DRAWINGS

FIG. 1 is a block diagram of a system that may be used to play a game of chance.

FIG. 2 is a block diagram of another system that may be used to play a game of chance.

FIG. 3 is a block diagram of a computing device that may be used with the system shown in FIG. 1 or the system shown in FIG. 2.

FIG. 4 is a block diagram of a gaming device that may be used with the system shown in FIG. 1 or the system shown in FIG. 2.

FIG. 5 is a block diagram of a plurality of program modules that may be used with the system shown in FIG. 1 or the system shown in FIG. 2 to administer a game of chance.

FIG. 6 is a flow diagram of a method of reporting player winnings that may be used with the systems and devices described herein.

FIG. 7 is a flow diagram of another method of reporting player winnings that may be used with the systems and devices described herein.

FIGS. 8A and 8B are perspective views of electronic gaming machines that may be used with the system shown in FIG. 1 or the system shown in FIG. 2.

FIG. 9 is a flow diagram of another method of reporting player winnings that may be used with the systems and devices described herein.

FIG. 10 is a flow diagram of another method of reporting player winnings that may be used with the systems and devices described herein.

FIG. 11 is an example of a printed slot voucher that may be used with the systems and devices described herein.

FIGS. 12A and 12B are examples of W-2G forms or reports that may be used with the systems and devices described herein.

FIG. 13 is a block diagram of another exemplary system for playing a game of chance.

### DETAILED DESCRIPTION

Systems and methods for reporting player winnings are described herein. In one embodiment, a plurality of gaming devices are connected to one or more servers over a network, such as a wide area network (WAN) and/or a local area network (LAN). In one embodiment, the gaming devices are electronic gaming machines (EGMs), otherwise known as “slot machines.” These may be classified as Class II, Class III, video lottery terminals (VLT), or the like. EGMs may present either one or a plurality of games to the player such as video reels, video poker, video keno, video bingo, and the like. In another embodiment, the gaming devices are gaming kiosks or terminals. Alternatively, the gaming devices may include, for example, cellular phones, and/or any other suitable devices. The servers may include one or more local servers within a gaming establishment and/or one or more wide area progressive (WAP) servers connected to the local servers and/or to the gaming devices through the network.

In one embodiment, each gaming device presents either one or a plurality of games of chance to a player to enable the player to select and play the games of chance. In addition, each gaming device may include a randomization device, such as a random number generator (RNG) and/or a permutation generator, that is used to play a selected game on the gaming device. The randomization device may be used to randomly determine a game outcome for the game of chance. For example, if the player selects a game of bingo to be played on a gaming device, the gaming device uses the randomization device to select a plurality of house indicia from a pool of 75 indicia (or from a different sized pool) to be used during the game. In another embodiment, at least some aspects of one game are provided by one or more servers, such as a local server, a wide area server, a local area progressive server (LAP), or a wide area progressive server (WAP). The server or servers may include a randomization device for randomly selecting the house indicia in the bingo game.

In the example of a video poker game, either one or a plurality of games are presented to the player. After game selection and wagering, a number of playing cards, generally selected from a 52 card deck, are distributed to the player. In the case of draw poker or its many variants, the player selectively chooses to retain one or more of the original cards dealt and to discard those cards not chosen to be retained. The discarded cards are then replaced by new cards. If the player obtains a predefined winning combination of cards, the player wins an amount associated with the particular combination of cards.

In the example of mechanical, electromechanical, or video reel machines, the games may include a number of mechanical or simulated rotating reels that are arranged in a horizontal or vertical configuration forming columns or rows. One or a number of rows, columns or similar are presented to the player to allow for one or many different winning pay lines. Pay lines may be straight across or designed in any convenient fashion. A typical game many include five reels or columns and three or four rows or the like.

In the example of the bingo game, the house indicia are compared to a plurality of player indicia that are included within a pattern selected for one or more player cards. If at least some of the player indicia within the pattern are matched by the house indicia, the player may win a prize based on the number of house indicia that have been matched and an associated pay table.

In the example of a keno game or a keno-related game of chance, the gaming device uses the randomization device to randomly select a plurality of house indicia in a similar manner as described with respect to the game of bingo. However, the house indicia are typically randomly selected, or called, from a pool of 80 house indicia, although other sizes of house indicia pools may be used. The called house indicia are compared to a plurality of player indicia to determine how many player indicia are matched by the house indicia and may be irrespective of a pattern of the player indicia. The embodiments described herein may include allowing the player to select the number of and specific player indicia to be utilized for a keno game or may include an automated or quick pick selection. For example, a player may select one player indicia or spot to play a 1 spot game, 2 player indicia or spots for a 2 spot game, 3 player indicia or spots for a 3 spot game, etc. Embodiments may also include a maximum number of player indicia or spots that are playable. For example, in an 80 number game, the maximum number of house indicia or spots selectable by the player may be confined to 20 numbers or less or a 20 number game or less. Accordingly, in an 80 number game, the minimum number of player indicia or spots may be 1 and the maximum player indicia or spots may be 20. The player may win one or more prizes based on the number of player indicia matched by the called house indicia.

In the example of sports wagering, a player may be seated in a player area that may include a betting terminal which includes a monitor and input means. A player may make or place periodic wagers on a variety of sporting events.

In the example of table games wagering, a player may play games such as blackjack, craps, roulette, baccarat, pai gow or the like where wagers and/or wins are tracked by the casino staff either manually or electronically. In the case of manual tracking, the staff records the player buy in amounts and upon the conclusion of play, the staff records the player's exiting total chip value generally after the player “colors up”. In the case of electronic tracking, a radio frequency ID (RFID) chip may be embedded into the casino chips whereby tracking is automatic. It is understood that any tracking system may be utilized for the present invention.

In one embodiment, as the player plays the games, the gaming device, an accounting system, and/or another suitable system or device tracks an amount of money or credits wagered by the player and an amount of money or credits won or lost by the player. In one embodiment, if the player wins a prize that exceeds a predetermined threshold, a W-2G form or another suitable report may be generated when the player cashes out of the gaming device or when another suitable reporting event occurs. Alternatively, a W-2G form or other report may be generated when a suitable reporting event occurs regardless of whether the player wins a prize that exceeds the threshold. The W-2G form may include each jackpot won by the player that is equal to or that exceeds the threshold during a gaming session. Alternatively, a separate W-2G form may be automatically generated for each jackpot won by the player that is equal to or that exceeds the threshold. In addition to or an alternative to W-2G forms and the like, other reports may be generated such as win/loss statements or loss statements. Forms or reports may be generated and/or printed by the printer associated with the gaming device, the accounting system or the like. For example, many gaming devices have the ability to print and produce slot vouchers. This ability to print and produce may also be adaptable for the reporting or forms necessary under the present invention.

Additionally or alternatively, the gaming device, the accounting system, and/or another suitable system or device may calculate a net win amount for the player during the gaming session or during another suitable period of time such as annually, monthly, daily, during a player visit or may be initiated by the player upon their completion of play. The net win amount may be calculated by subtracting a total amount of money or credits wagered by the player from a total amount of money or credits won by the player. Alternatively, the net win amount may be calculated by subtracting the summed total amount of money or credits wagered by the player from a summed total of all jackpots won by the player that are equal to or that exceed the predetermined threshold. It is understood that jackpots may refer to payouts in excess of a threshold amount and may refer to any win amount. A W-2G form or another suitable report with the net win amount may be prepared for the player upon cash out or upon another suitable reporting event such as end of the year reporting.

It is understood that in all embodiments, a player will be required to provide identification information including at least their social security number or other taxpayer identification number. The providing of identification information may occur at the time of a reporting event for the player or the providing of identification information may occur prior to the time of a reporting event for the player by submission to the accounting department, the casino cage, at the gaming machine by any suitable means or the like.

In one embodiment, the W-2G form may include the wins (i.e., individual prizes and/or the net win amount) that are equal to or that exceed the predetermined threshold (“reportable wins”) during a gaming session. Alternatively, the W-2G form or other report may include all reportable wins or the total number of wins that occur during a day, a month, a year, and/or any other suitable period of time.

Accordingly, the embodiments described herein may significantly improve the efficiency of the reporting of player wins including, but not limited to, wins that are equal to or that exceed the predetermined threshold, such as the threshold established by the IRS. The embodiments described herein may also improve the accuracy and efficiency of the win reporting, may interrupt the player's gameplay significantly less than existing reporting methods and significantly reduce labor costs.

A technical effect of the systems and methods described herein includes one or more of: (a) providing a gaming device that includes a randomization device and a gaming processor; (b) randomly selecting a plurality of house indicia associated with a game of chance using the randomization device; (c) presenting the game of chance to a player using the gaming processor; (d) providing an accounting system; (e) providing a wagering metering device included within the gaming device or the accounting system; (f) determining an amount of money or credits wagered by the player using the wagering meter; (g) providing a win meter included within the gaming device or the accounting system; (h) determining an amount of money or credits won by the player using the win meter; (i) determining a net win amount based on the amount of money or credits wagered by the player and the amount of money or credits won by the player; and (j) generating a report including the net win amount upon a determination that a reporting event has occurred. It is understood that a reporting event may include all events whether they have or have not met a prescribed threshold.

As used herein, a “game of chance” or “game” refers to a game that is played by a player in which an outcome of the game of chance is at least partially based on chance or a random selection of game components. A game may be categorized by a game variety and/or a game size, for example. It should be recognized by those of ordinary skill in the art that the term “random” is not limited to true randomness, such as truly random numbers. Rather, pseudorandom numbers and pseudorandom algorithms are included within the meaning of “random.” In addition, those of ordinary skill in the art will recognize that permutation generators may additionally or alternatively be used to generate player card indicia or other game components.

Gaming devices described herein may use real money for play, or may utilize a credit-based system in which the credits used for the games do not have a cash value. Similarly, prizes for the games may be in the form of credits, cash, and/or physical prizes such as televisions, automobiles, or the like.

The play of a game, or the gameplay, may include the random drawing or selection of a plurality of house indicia. The house indicia may be drawn or selected until a game ending criteria is met or until a predetermined number of house indicia have been selected. In an embodiment where the game being played is a reel-based game (sometimes referred to as a “slot game” or a “slot machine game”), the gameplay may include a random selection of house indicia displayed on the reels of the game. In an embodiment in which the game being played is a bingo or keno game, the gameplay may include a random drawing or selection of numbered balls or other house indicia.

As used herein, the term “player indicia” refers to indicia, such as objects, graphics, symbols, numbers, letters, or the like, that may be printed on, displayed on, or otherwise associated with a player card used by the player to play a game of chance. In at least some embodiments, the player may select one or more player indicia for each player card.

The term “house indicia” or “game indicia” refers to indicia, such as objects, graphics, symbols, numbers, letters, or the like, that may be generated, called, or otherwise selected by a gaming establishment or an operator of the game. In an embodiment in which the game played is a slot game, the selected house indicia may be compared to predetermined winning patterns of house indicia to determine whether the player wins a prize. In an embodiment in which the game played is a bingo or keno game, the selected house indicia are compared to player indicia on each player card to determine if each player card satisfies one or more winning conditions, such as matching a predetermined pattern or matching a predetermined number of indicia on the player card.

The term “ball call” refers to a random selection of house indicia in connection with a game of chance. The terms “select,” “draw,” “call,” “determine,” and “generate” are used interchangeably with respect to the selection of house indicia, numbers, or balls in a game. A ball call may include drawing or receiving a random ball with a number indicated on the ball, or may more generally refer to a random selection of a number or another suitable house indicia using a randomization device. A “ball,” as used herein, may be a round plastic, wood, or glass spherical object with a number or other indicia displayed thereon, or may be an electronic representation of a spherical object with a number or other indicia displayed thereon. It should be recognized that the term “ball” may also include non-spherical objects or electronic representations, such as cubes, electronic images, and/or the numbers or indicia by themselves.

As used herein, the term “pattern” refers to a predetermined combination of spaces or indicia of a player card, a reel, or the like. In at least some embodiments, a winning combination is satisfied if player indicia included within the spaces associated with a pattern are matched to house indicia called during the game.

As used herein, the term “the house” refers to a game operator or a gaming establishment operator. For example, if a game is operated within or by a casino, the casino may be referred to as the house. Alternatively, the house may refer to a software application contained within a mobile device, such as a cell phone or a tablet computing device, that operates the game on the mobile device.

As used herein, the term “fixed prize” or “fixed payout” refers to a prize or payout that is a predetermined multiple of an amount wagered on the game, or that is a fixed amount regardless of the amount wagered. The fixed prizes or payouts are typically listed on a pay table associated with the game.

In contrast, progressive prizes or payouts are prizes or payouts in which at least a portion of the payout or prize increases or changes based on the amounts wagered by the players who are playing the game to win the progressive prize.

The term “meter” may refer to various types of devices or processors or the like such as a discrete computerized device or may exist as a software implementation within an accounting system or similar. Meters may be used to track an amount of money or credits wagered, won, and/or lost and to output a signal or data representative of the tracked amount.

Any suitable game of chance may be played that operates according to the described embodiments. Example games of chance playable according to the disclosure herein include video poker, video reel slots, a keno or keno-related game, a bingo or bingo-related game, table games, and sports betting. However, it should be emphasized that these games are merely exemplary, and any other suitable game may be played as described herein.

A “local game” is a game that is played by players within a predetermined location, such as within a single gaming establishment, or players playing the game across a local area network. A “local prize” or a “local payout” (including a local progressive prize or a local progressive payout) is a prize that may be won during a local game.

In some embodiments, different groups of players may qualify to compete to win different prizes. For example, a first group of players positioned in a gaming establishment may be able to compete to win one or more local prizes (e.g., progressive prizes and/or pari-mutuel prizes) while a second group of players may not be able to compete to win those prizes, for example, if the second group of players is positioned outside of the gaming establishment. However, the first group of players and the second group of players may be able to compete to win one or more other shared or common prize, such as one or more progressive and/or pari-mutuel prizes administered over a wide area network.

An “individual prize” is a prize that is only awarded to a player of an individual gaming device. For example, if a group of players are playing a game over a network, the game may provide one or more individual prizes that are tied to a single gaming device such that the individual prizes are only able to be won by the player of the gaming device. Individual prizes are sometimes referred to as gaming device specific player prizes because the individual prizes are specific to a player's gaming device. Accordingly, while a plurality of players may play to win one or more shared or common progressive prizes and/or pari-mutuel prizes, each player is prevented from winning individual prizes associated with, or “tied to,” any other player's gaming device.

As used herein, the terms “connect” and “couple” are not limited to only including direct connections. Rather, unless otherwise specified, indirect connections are included within the definitions of “connect” and “couple.” For example, two devices may be considered to be connected together even if there are other devices or components connected between the two devices. Any suitable means to connect or couple devices or components together may be used.

A player reward card refers to a physical or electronic card, token, or other device or data that enables a system to identify a player in connection with, among other things, a reward program or campaign. Accordingly, the player reward card may serve to identify the player and may enable gameplay, credits, funds, or other data to be associated with the player.

A player card refers to a card that may be used by the player to play bingo or another game of chance. The player card typically includes a plurality of spaces that may display or include player indicia. The player card may be an electronic card that is transmitted to a device or generated by a device that the player is using to play the game of chance. Alternatively, the player card may be manufactured from paper, cardboard, cardstock, plastic, and/or any other suitable material and may include magnetic strips, RFID tags and the like.

Methods described herein may be embodied within a plurality of instructions stored within a memory device of a computing device. Moreover, a processor of the computing device, or of a computing device coupled to the memory device, executes the instructions to perform the functions described herein and/or to cause the functions described herein to be performed. The instructions may be grouped together to form one or more computer-readable program modules.

Computing devices typically include at least one processor and at least one memory device. The processor may be, without limitation, an x86-based logic circuit, an ARM-based logic circuit, and/or a system-on-a-chip circuit. It should be recognized that these examples are non-limiting, and a variety of other programmable circuits may be included within the definition of “processor.” The memory device may include random access memory (RAM), flash memory, read-only memory (ROM), hard disk drives, magnetic-based memory, and/or any other form of computer-readable memory.

A desktop computer is one example of a computing device. Other examples of computing devices include, without limitation, electronic gaming machines (also known as slot machines), kiosks, cell phones, tablets, PDAs, laptop computers, and smart watches. It should be recognized that computers or computing devices may be implemented as one or more virtual machines, virtual servers, and/or any other virtual device. A server is another type of computing device that may receive network connections from a computer or a plurality of computers or other computing devices.

As used herein, the term “module” or “program module” refers to a computer program, dataset, and/or instruction set that, when executed by a processor, performs the functions described herein. In one embodiment, the module may be included within a computer program, or may be connected to a computer program in any suitable manner. Any computer readable instructions may be programmed or hard-coded in a device, such as a gaming device, in any suitable manner.

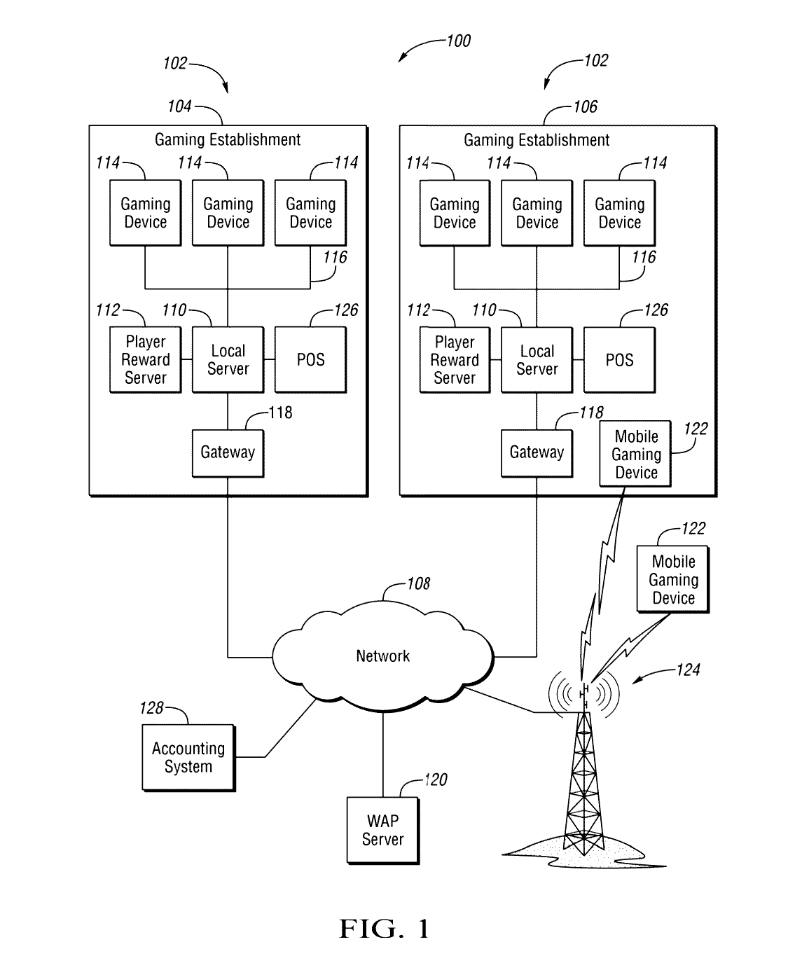

FIG. 1 is a block diagram of a system 100 that may be used to play one or more games of chance, such as video poker, video slots, race or sports betting, table games, bingo, keno, or the like. The games of chance may be played by a player against other players, or may be played by the player against the house.

System 100 is operated using components and devices within one or more gaming establishments 102, such as a first gaming establishment 104 and a second gaming establishment 106. It should be recognized that any suitable number of gaming establishments 102 may be provided within system 100. Accordingly, system 100 is not limited to including two gaming establishments 102 as illustrated in FIG. 1. In one embodiment, gaming establishments 102 are locations in which devices (e.g., gaming devices) that play or operate at least a portion of the game of chance are located. For example, gaming establishments 102 may be casinos, racetracks, bingo halls, keno parlors, or any other establishments. In another example, gaming establishments 102 may be residences or businesses in which one or more devices are located for playing or operating the game of chance. Gaming establishments 102 may additionally or alternatively include any combination of the examples described herein.

In one embodiment, gaming establishments 102 are physically remote from each other and are communicatively connected to at least one network 108, such as a wide area network (WAN), a metropolitan area network (MAN), and/or the Internet, for example. Alternatively, gaming establishments 102 may be separate rooms or sections of a casino or another facility that are communicatively connected together by network 108. It should be recognized that network 108 may be a wired Ethernet network, a wireless Ethernet network, a combination of wired and wireless Ethernet networks, or any other suitable wired and/or wireless network.

In one embodiment, each gaming establishment 102 includes a local game server 110 (referred to herein as a “local server”) and a player reward server 112. Local server 110 and player reward server 112 may alternatively be implemented as or within a single server. Local server 110 is coupled to a plurality of gaming devices 114 through an internal network 116, such as a private local area network (LAN) within gaming establishment 102, for example. Gaming devices 114 may be located in separate gaming establishments 102, or within the same gaming establishment 102. In one embodiment, a gateway 118 is provided to enable local server 110 of each gaming establishment 102 to securely connect to network 108.

In one embodiment, local server 110 is a server computer (or “server”) that monitors and controls the games played on gaming devices 114, including local games. In one embodiment, the local games include games that are played against the house and/or that are played against other players within gaming establishment 102.

In addition, local server 110 may administer other background tasks that enable games to be played on gaming devices 114. For example, local server 110 may facilitate authenticating gaming devices 114 and the players using gaming devices 114, and may facilitate allocating payments or credits between players and the house. Local server 110 may include payment processing capabilities to enable players to receive electronic funds from a bank or another financial institution or to deposit electronic funds to the bank or financial institution. Alternatively, the payment processing capabilities may be included in a separate server or another device that is communicatively connected to local server 110. In addition, local server 110 may interface with player reward server 112 to facilitate tracking and administering player rewards. Each gaming device 114, group of gaming devices 114, local servers 110, player reward servers 112, or the like may collect and/or generate data desired for accounting purposes, such as for use in slot accounting systems.

In one embodiment, local server 110 may enable gaming devices 114 within gaming establishment 102 to participate in one or more games that share one or more progressive or pari-mutuel prizes with other gaming establishments 102 and/or gaming devices 114. While progressive prizes are described in embodiments herein, it should be recognized that pari-mutuel prizes may be substituted as desired, and vice versa. In such an embodiment, each local server 110 may be coupled to a wide area progressive (WAP) server 120 that administers the prizes. For example, WAP server 120 receives data from each local server 110 and/or from gaming devices 114 regarding an amount wagered by each player playing the game. WAP server 120 may allocate a portion of each wager to the prizes and may communicate the current prize amounts to local servers 110 and/or to gaming devices 114.

Gaming devices 114 may include one or more gaming kiosks or terminals, electronic gaming machines (EGMs) (also known as “slot machines”), lottery kiosks or terminals, or any other suitable device. Mobile gaming devices 122 may include specialized gaming tablet computers or the like that connect to local server 110, WAP server 120, and network 108 via a wireless data network represented by cell tower 124. For example, mobile gaming devices 122 may connect to any suitable network 108 (and thereby to local servers 110 and/or WAP server 120) via a “3G” or a “4G” wireless data network. It should be recognized that mobile gaming devices 122 may additionally or alternatively connect to network 108 using another suitable wireless network, such as a wireless Ethernet network. For convenience, gaming devices 114 described herein may also include mobile gaming devices 122.

One or more point-of-sale (POS) terminals 126 may also be included within each gaming establishment 102 to enable players to “cash out” winnings from one or more gaming devices 114 and/or to perform other account management activities related to player accounts. POS terminals 126 may be connected to local server 110, for example, and/or to WAP server 120 as desired.

In addition, system 100 may include an accounting system 128 (sometimes referred to as a “slot accounting system”) coupled to WAP server 120, local server 110, and/or gaming devices 114, for example, through network 108. In one embodiment, accounting system 128 is a server or another suitable computer that includes at least one processor, at least one memory device, and at least one communication device. Accounting system 128 may be used to track and/or audit financial aspects of system 100 to ensure compliance with applicable regulations. While accounting system 128 is illustrated in FIG. 1 as being external to gaming establishments 104 and 106, it should be recognized that a separate accounting system 128 may be included within each gaming establishment 104 and 106.

In one embodiment, accounting system 128 interacts with gaming devices 114 within one or more gaming establishments 102 to implement a financial reporting framework. For example, accounting system 128 may transmit and receive data to and from gaming devices 114 for use in determining and reporting win amounts of players to the Internal Revenue Service (IRS) using a W-2G form or another suitable report format as described more fully herein.

In one embodiment, a plurality of gaming devices 114 having different operating systems and/or system architectures may connect to local server 110 or to another suitable server to play one or more games of chance. In such an embodiment, gaming devices 114 may be used to play a session bingo game, for example, or any other game of chance.

During operation, the player utilizes or selects a gaming device 114 and initiates a gaming session for playing one or more games of chance (“games”). Optionally, the player inserts a player reward card or enters a player reward number or other identification information into gaming device 114. If the identification information is entered, gaming device 114 transmits the identification information to local server 110 for authentication, or authentication may be accomplished locally within gaming device 114. Local server 110 communicates with player reward server 112 to establish the player's identity and to associate the gameplay with the player account. Local server 110 authenticates the player and gaming device 114 and authorizes the player to play the game or games on gaming device 114 if desired or required.

When play of the game is initiated, during selection of the game, or during play of the game, the player may be required to purchase or generate credits. The player may purchase or generate credits by inserting cash or a ticket-in-ticket-out voucher into gaming device 114 or another device. Alternatively or additionally, the player may transfer credits or cash to gaming device 114 from banking accounts, credit accounts, gaming establishment accounts, and/or gaming company accounts. In one embodiment, computer-generated credits may be used with gaming device 114, for example, as part of a free-to-play game.

The player selects a game to play and enters a wager on gaming device 114. Gaming device 114 transmits data representative of the selected game and the wager to local server 110. If the player selects a game that is at least partially operated by WAP server 120 or that includes one or more progressive prizes administered by WAP server 120, local server 110 transmits the wager and game information and/or selection to WAP server 120. WAP server 120 may increment the progressive prizes based on the wager received from the player and may communicate the updated prize amounts via network 108 to all other players (via associated gaming devices 114) playing to win the progressive prizes.

The player plays the game on gaming device 114. The following gameplay is described as being administered by WAP server 120. However, it should be recognized that the gameplay (i.e., the play of the game of chance) may be alternatively or additionally administered by local server 110 and/or gaming device 114. For example, if gaming device 114 is a cellular phone or a tablet computing device, the gameplay may be administered through an application installed on gaming device 114.

In one embodiment, the player may play a game of bingo by selecting a game or game type, one or more player cards, selecting one or more winning patterns for the player cards, and/or selecting one or more numbers or other player indicia for the player cards using gaming device 114. The selected player cards, winning patterns, and player indicia may be transmitted to WAP server 120. The player cards are included within one or more game tickets issued by WAP server 120, and the game tickets are communicated to gaming device 114 via network 108 and local server 110. WAP server 120 selects or receives randomly generated house indicia and compares the house indicia to the player indicia and the pattern or patterns selected for the player cards. Alternatively, the functions described herein (e.g., comparing the house indicia to the player indicia and the pattern or patterns selected for the player card) may be performed in gaming device 114. It should be recognized that the house indicia may be randomly generated using a randomization device, such as hardware, firmware, and/or software-based random number generator (RNG), a ball blower or console, a ball cage, and/or any other suitable device or machine that enables numbers or other house indicia to be randomly generated. In an alternative embodiment, WAP server 120 (or another device) may designate a server, computer, or another device to provide randomly selected house indicia during the game, and may receive the house indicia from the designated device.

WAP server 120 determines whether the player wins a prize based on the comparison of the house indicia to the player indicia. For example, WAP server 120 determines whether the player indicia within the pattern or patterns selected for each card match the house indicia that were randomly determined (sometimes also referred to as the house indicia that were “called”). If the player indicia within a pattern match the called house indicia, the player may win a prize based on a pay table associated with the game. The prize may be one of the progressive prizes, the prize may be a fixed prize identified in the pay table or may be a pari-mutuel prize. WAP server 120 determines the appropriate payout to be paid to the player based on the pay table and transmits data representative of the payout to local server 110.

Local server 110 receives the payout data and credits the player account accordingly. In addition, local server 110 may transmit the gameplay data and/or payout data to player reward server 112 to enable player reward server 112 to update the player history and other gameplay data for the player. When the player is done playing, the player may “cash out” some or all of the credits in the player account or may deposit the credits into the player account using POS terminal or kiosk 126, for example. The player account may be stored on gaming device 114, local server 110, or player reward server 112, for example.

In one embodiment, the player may enter the wager and/or may initiate play of the game on a first gaming device 114 and may complete the gameplay on a second gaming device 114. Alternatively, the player plays the game on first gaming device 114 and receives the results of the gameplay (e.g., whether the player won and how much the winnings are) on second gaming device 114. For example, the player may begin playing the game on a kiosk or electronic gaming machine, and may complete the game or view the results of the game on a cell phone. In such an embodiment, WAP server 120 and/or local server 110 may transmit the player's gameplay data from the 1st gaming device 114 to the second gaming device 114.

While the foregoing embodiment is described with reference to games of chance played on gaming devices 114, it should be recognized that system 100 may be used with other games of chance, such as sports or race betting, that may not use gaming devices 114. In such an embodiment, a player may enter a wager on a sports game or a race at a betting terminal such as POS terminal 126 or another suitable device or system. The player may also be required to enter an identification, such as a taxpayer identification number or card (e.g., a social security number or card) or the like. POS terminal 126, local server 110, WAP server 120, and/or any other suitable computing device may store or record the amount wagered, an amount won or lost, and/or the player's identification in memory. POS terminal 126 may additionally or alternatively transmit data representative of the amount wagered, won, and/or lost to local server 110, WAP server 120, and/or any other suitable computing device for tracking purposes and/or for generating reports of the player's wagering and win/loss activity.

One or more reports may be issued that include individual or total amounts wagered, won, and/or lost for the player as described more fully herein. The report may also or alternatively include a net win amount of the player that is equal to the total amount won by the player minus the total amount wagered by the player within a predetermined time period and may include the net win/loss by the player or the loss by the player. Accordingly any win or the amount won by the player may include both positive and negative amounts whether incrementally or in the aggregate. In one embodiment, the report may include a W-2G form that may be issued to the player and/or may be submitted to the Internal Revenue Service (IRS). The report or reports may be printed or otherwise issued to the player through POS terminal 126 or any suitable device or system such as an EGM or the like in one embodiment. In another embodiment, POS terminal 126, local server 110, WAP server 120, and/or any other suitable device or system may transmit the report or reports via an email, a link to a webpage, or another electronic communication to a device or account of the player. Additional information may be included in the report such as a player's name, player's address, player's phone number, player's social security number, gaming establishment's name, gaming establishment's address, gaming establishment's phone number, gaming establishment's employer identification number (EIN), etc. Further, any or all information may be encrypted for security purposes.

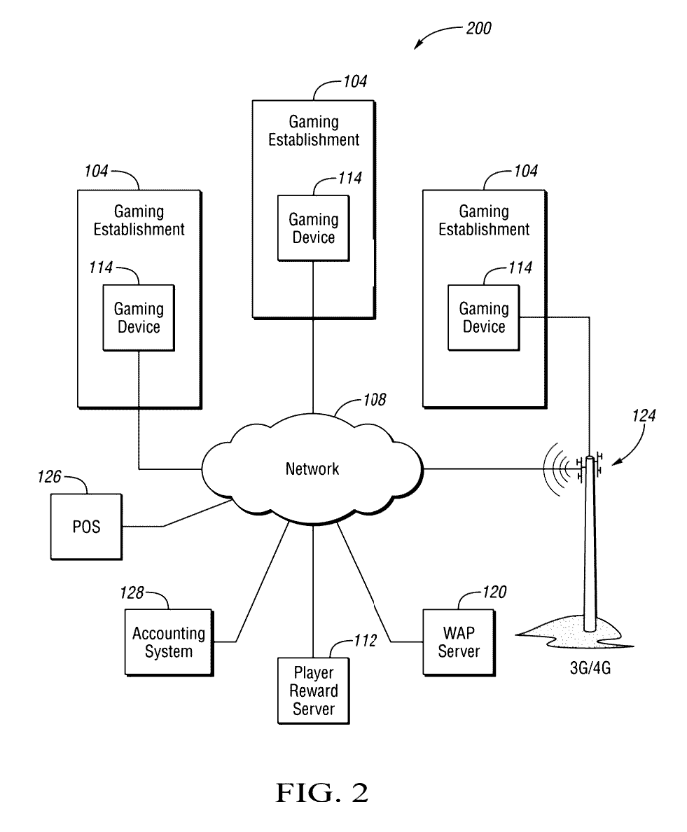

FIG. 2 is a block diagram of another system 200 that may be used to play one or more games of chance. Unless otherwise specified, system 200 is similar to system 100 (shown in FIG. 1) and similar components are labeled in FIG. 2 with the same reference numerals used in FIG. 1. It should be understood that more or less components may be included within the various embodiments described herein.

In the embodiment shown in FIG. 2, system 200 includes a plurality of gaming devices 114 that are positioned in a plurality of gaming establishments 102. Gaming devices 114 may connect to network 108 without using a local server 110 (shown in FIG. 1), and may connect to WAP server 120 and/or to player reward server 112 through network 108. For example, gaming devices 114 may be playing one or more Internet-based games that connect to WAP server 120 through a web server. In some embodiments, one or more gaming devices 114 may connect to WAP server 120 and/or to player reward server 112 through a wireless data network as described above. Accordingly, gaming devices 114 interact with WAP server 120 to play the game, and WAP server 120 performs the game administration and other tasks handled by local server 110 as described above in FIG. 1. In a similar manner, POS terminal 126 and accounting system 128 may connect to gaming devices 114 and/or WAP server 120 via network 108. In other respects, system 200 performs in a similar manner as described above.

During operation, the player utilizes or selects a gaming device 114 and initiates a gaming session to play one or more games on gaming device 114. The player inserts a player reward card or enters a player reward number or other identification information into gaming device 114. Gaming device 114 transmits the identification information to player reward server 112 to establish the player's identity and to associate the gameplay with the player account. Player reward server 112 authenticates the player and gaming device 114 and authorizes the player to play the game on gaming device 114. In one embodiment, gaming device 114 also transmits the identification information to WAP server 120 to enable WAP server 120 to associate the player with the game to be played. As previously described, player identification or authentication may be optional.

In another embodiment, WAP server 120 authenticates the player using the player identification information in addition to, or instead of, the authentication performed by player reward server 112. In some embodiments, player reward server 112 is omitted and the functions of player reward server 112 are incorporated within WAP server 120.

The player selects a game to play and enters a wager using gaming device 114. If the player selects a game that is operated by WAP server 120 or that includes one or more progressive prizes administered by WAP server 120, gaming device 114 transmits the wager and game selection to WAP server 120. WAP server 120 may increment the progressive prizes based on the wager received from the player and may communicate the updated prize amounts via network 108 to all other players (via associated gaming devices 114) playing to win the progressive prizes.

The player plays the game on gaming device 114. The following gameplay is described as being administered by WAP server 120. However, it should be recognized that the gameplay may be alternatively or additionally administered by gaming device 114. For example, if gaming device 114 is a cellular phone or a tablet computing device, the gameplay may be administered through an application installed on gaming device 114.

In one embodiment, the player may play a game of bingo by selecting one or more player cards, selecting one or more winning patterns for the player cards, and/or selecting one or more numbers or other player indicia for the player cards using gaming device 114. In another embodiment, the player may play a game of keno by selecting one or more player cards and selecting one or more numbers or other player indicia for the player cards using gaming device 114. The selected player cards, winning patterns (for example, in the bingo embodiment), and player indicia are transmitted to WAP server 120. The player cards are included within one or more game tickets issued by WAP server 120, and the game tickets are communicated to gaming device 114 via network 108 and local server 110. WAP server 120 selects or receives randomly generated house indicia and compares the house indicia to the player indicia and the pattern or patterns selected for the player cards. It should be recognized that the house indicia may be randomly generated using a randomization device, such as hardware, firmware, and/or software-based random number generator (RNG), a ball blower or console, a ball cage, and/or any other suitable device or machine that enables numbers or other house indicia to be randomly generated.

WAP server 120 determines whether the player wins a prize based on the comparison of the house indicia to the player indicia. For example, in an embodiment in which the player plays a game of bingo, WAP server 120 determines whether the player indicia within the pattern or patterns selected for each card match the house indicia that were randomly determined. If the player indicia within a pattern match the called house indicia, the player wins a prize based on a pay table associated with the game. In an embodiment in which the player plays a game of keno, WAP server 120 determines whether the player indicia selected for each card match the house indicia that were randomly determined. If a predetermined number of the player indicia match the called house indicia, the player wins a prize based on a pay table associated with the game. The prize may be one of the progressive prizes or the prize may be a fixed prize identified in the pay table. WAP server 120 determines the appropriate payout to be paid to the player based on the pay table and transmits data representative of the payout to gaming device 114 for display to the player.

WAP server 120 also credits the player account to reflect the prize that was won by the player. In addition, WAP server 120 may transmit the gameplay or payout data to player reward server 112 and to accounting system 128 to enable player reward server 112 and accounting system 128 to update the player history and other gameplay data for the player. When the player is done playing, the player may “cash out” some or all of the credits in the player account and/or gaming device 114 or may deposit the credits in the player's account using POS terminal 126, for example.

In one embodiment, the player may enter the wager and/or may initiate play of the game on a first gaming device 114 and may complete the gameplay on a second gaming device 114. Alternatively, the player plays the game on first gaming device 114 and receives the results of the gameplay (e.g., whether the player won and how much the winnings are) on second gaming device 114. For example, the player may begin playing the game on a kiosk or electronic gaming machine, and may complete the game or view the results of the game on a cell phone. The game completion may be for a game currently being played, and/or may be for one or more future games (i.e., one or more games that have not yet started). For example, the player may enter sufficient credits or other consideration into gaming device 114 to purchase gameplay for a plurality of future games that use the same player card or that use other preselected or random player cards. The player may then complete one or more of the future games on another gaming device 114 (or any other suitable device) and/or may receive the result of one or more of the future games on another gaming device 114 (or any other suitable device).

In one embodiment, the player may purchase any number of future games (i.e., games to be played in the future) by entering a wager, a number of cards to play for each game, and a number of games to play. After inserting sufficient cash or credits to pay for the games, WAP server 120 or another device or machine that is administering the game (such as gaming device 114) may automatically display the called house indicia for each game and a result of each game to the player. The player may watch the results of the game in real time, or may view the results at a later time, for example, by viewing a summary of the game results. The player may view the results (in real time or later) on the same gaming device 114 used to initiate the games and enter the wagers, on another gaming device 114, or on any other suitable device.

In another embodiment, such as an embodiment in which the game is administered through an application installed on a cell phone, a tablet computing device, or another gaming device 114, WAP server 120 only administers the progressive prizes, or some or all prizes associated with the game being played. In such an embodiment, gaming device 114 randomly selects the house indicia using a randomization device included within, or connected to, gaming device 114. In addition, gaming device 114 may determine whether the player indicia within the player selected pattern match the house indicia, thus determining whether the player wins a prize. Gaming device 114 may transmit the results of the game to WAP server 120. The results of the game may include, for example, an indication whether the player won, the house indicia randomly selected, the player indicia selected, the player pattern selected, the number of ball calls that were required to match the house indicia to the player indicia, and/or any other aspect of the game.

In one embodiment, WAP server 120 confirms the result of the game before awarding the prize to the player. For example, WAP server 120 may determine whether the house indicia match the player indicia within the player selected pattern independently of the game result reported by gaming device 114.

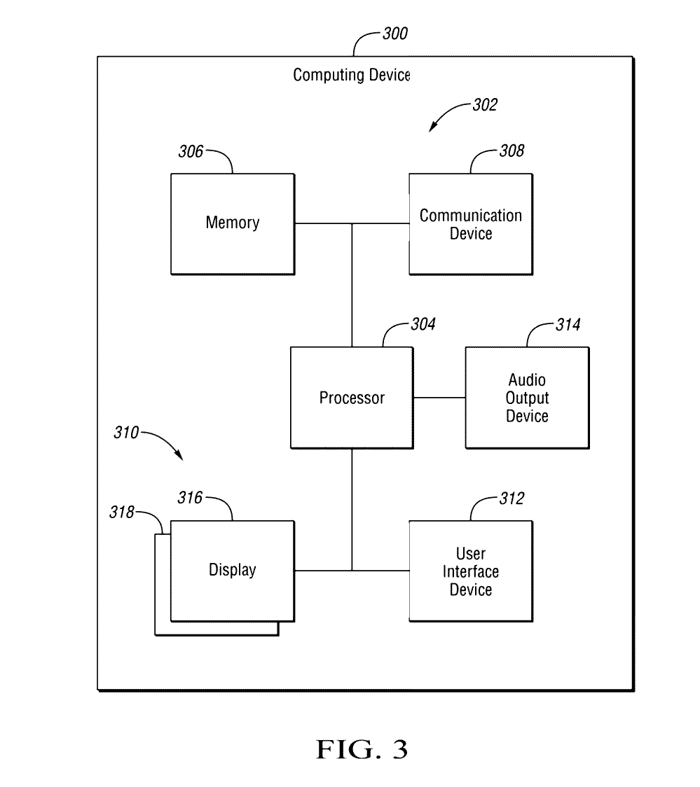

FIG. 3 is a block diagram of a computing device 300 that may be used with system 100 (FIG. 1) or system 200 (shown in FIG. 2). More specifically, one or more gaming devices, servers, or other devices described in system 100 or system 200 may be implemented as a computing device 300. For example, local server 110, WAP server 120, player reward server 112, accounting system 128, gaming devices 114, and/or mobile gaming devices 122 may be computing devices 300.

Computing device 300 includes a plurality of computing device components 302, such as a processor 304, a computer-readable memory device 306, and a communication device 308. In one embodiment, computing device 300 may also include a display 310, a user interface device 312, and/or an audio output device 314. It should be recognized that memory device 306, communication device 308, display 310, and user interface device 312 (if provided) may be connected to processor 304 and/or to each other via any suitable bus or busses, interfaces, or other mechanisms.

Processor 304 includes any suitable programmable circuit including one or more microcontrollers, microprocessors, application specific integrated circuits (ASICs), systems on a chip (SoCs), programmable logic circuits (PLCs), field programmable gate arrays (FPGAs), and/or any other circuit capable of executing the functions described herein. The above examples are exemplary only, and thus are not intended to limit in any way the definition and/or meaning of the term “processor.”

Memory device 306 is an electronic storage device that includes transitory or non-transitory computer readable media, such as, without limitation, random access memory (RAM), flash memory, a hard disk drive, a solid state drive, a compact disc, a digital video disc, and/or any suitable memory. Memory device 306 may include data as well as instructions that are executable by processor 304 to program processor 304 to perform the functions described herein. For example, the methods described herein may be performed by one or more processors 304 executing instructions stored within one or more memory devices 306.

Communication device 308 may include, without limitation, a network interface controller (NIC) or adapter, a radio frequency (RF) transceiver, a public switched telephone network (PSTN) interface controller, or any other communication device that enables computing device 300 to operate as described herein. In one embodiment, communication device 308 may connect to communication devices 308 of other computing devices 300 of system 100 or system 200 through network 108 or another network using any suitable wireless or wired communication protocol.

Display 310 may include, without limitation, a liquid crystal display (LCD), a vacuum fluorescent display (VFD), a cathode ray tube (CRT), a plasma display, a light-emitting diode (LED) display, a projection display, and/or any suitable visual output device capable of displaying graphical data and text to a user. For example, display 310 may be used to display a graphical user interface to a player or an administrator, one or more images associated with a game such as bingo, keno, or another game of chance, player statistics, gameplay data, and/or any other suitable data.

User interface device 312 may include, without limitation, a keyboard, a keypad, a touch screen, a mouse, a scroll wheel, a pointing device, an audio input device employing speech-recognition software, a video input device that registers movement of a user, and/or any other suitable device that enables the user to input data into computing device 300 and/or retrieve data from computing device 300.

Audio output device 314 may include, without limitation, one or more speakers, or any other device that enables data to be audibly output from computing device 300. For example, gameplay data and/or music may be audibly output from audio output device 314. In addition, if the player wins a prize, audio output device 314 may be used to alert the player and/or others about the win.

While the foregoing computing device components 302 have been described as being included within a computing device 300, it should be recognized that at least some computing devices 300 may not include each component 302. For example, a computing device 300 may not include audio output device 314. In addition, a computing device 300 may include any suitable number of each individual computing device component 302. For example, a computing device 300 may include a plurality of processors 304 or processor cores and/or a plurality of memory devices 306 (of the same or different types, sizes, etc.). In addition, computing device 300 may include a plurality of displays 310, such as a first display 316 and a second display 318. In one embodiment, first display 316 may provide a graphical user interface to a player, and second display 318 may display one or more aspects of gameplay to the player as described more fully herein. Alternatively, first display 316 and second display 318 may display any suitable aspect of the game as desired.

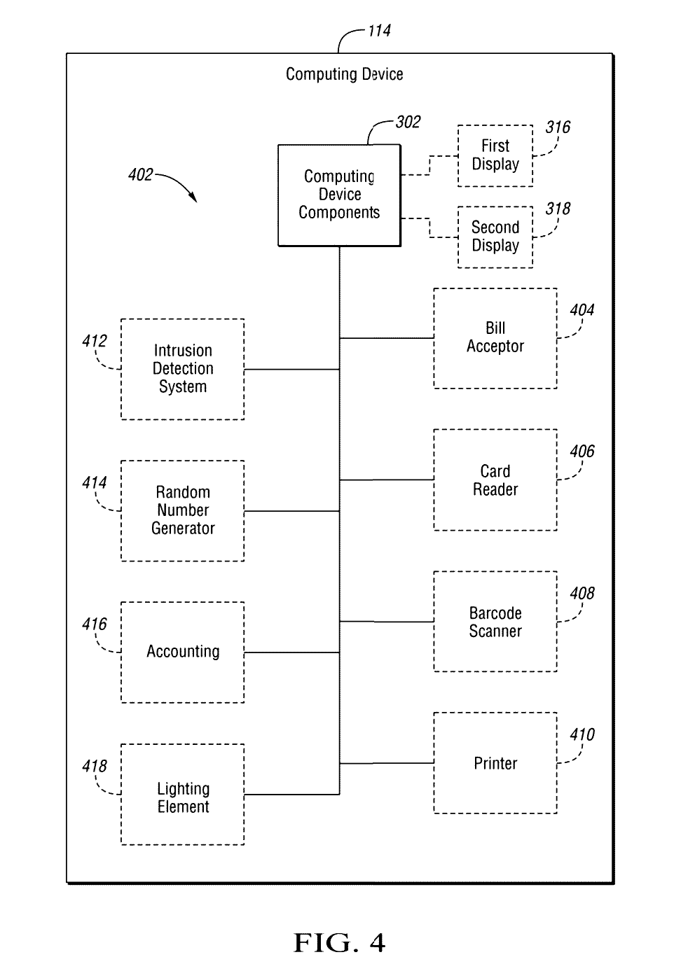

FIG. 4 is a block diagram of a gaming device 114 that may be used with system 100 (shown in FIG. 1) or system 200 (shown in FIG. 2). As described above, gaming device 114 is a computing device 300 (such as an EGM or a kiosk) that includes a plurality of computing device components 302 positioned within a cabinet or other housing. In one embodiment, computing device components 302 include first display 316 and second display 318. In addition, gaming device 114 may include a plurality of gaming device components 402 including a bill acceptor 404, a card reader 406, a barcode scanner 408, a printer 410, an intrusion detection system 412, a randomization device 414, and/or an accounting interface 416 that are positioned within, or coupled to, the cabinet or housing. In one embodiment, gaming device 114 may also include at least one lighting element 418 coupled to the cabinet or housing.

It should be recognized that in some embodiments, a gaming device 114 may not include each gaming device component 402 illustrated in FIG. 4. For example, if gaming device 114 is a cellular phone, gaming device 114 may not include bill acceptor 404, card reader 406, barcode scanner 408, and/or printer 410. Rather, in some embodiments, the functions of each omitted gaming device component 402 may be replaced by equivalent software, hardware, and/or firmware if desired. Optional components may be designated using dashed lines in the figures.

Bill acceptor 404 is a payment input device that enables gaming device 114 to receive and identify paper currency, credit vouchers or the like. For example, bill acceptor 404 may receive and identify physical items associated with a monetary value, such as dollar bills, vouchers or other currency, that are inserted into bill acceptor 404. In one embodiment, bill acceptor 404 includes a scanner that scans paper currency inserted therein. Bill acceptor 404 may also include optical character recognition (OCR) capabilities that enable bill acceptor 404 to identify the amount of currency inserted into bill acceptor 404 from a scanned image of the currency. Bill acceptor 404 may transmit data representative of the amount of currency inserted into gaming device 114 to processor 304, for example. Processor 304 may cause the amount of currency to be converted into credits usable with the game, and may add the credits to the player's credit balance or account.

Card reader 406 is a device that “reads,” or obtains data encoded in, player reward cards or other cards or media that are inserted into reader 406. In one embodiment, card reader 406 is a magnetic card reader that reads barcodes or magnetic strips included within a player reward card. In another embodiment, card reader 406 wirelessly reads data encoded within the player reward card by accessing a chip, such as a radio frequency identification (RFID) chip or similar, embedded within the card. Card reader 406 decodes the data obtained from the cards and transmits the decoded data to processor 304. In one embodiment, card reader 406 is used to read player identification information encoded within player reward cards. Processor 304 may transmit the player identification information to player reward server 112 to identify the player, to allow for the transfer of funds or credits, to facilitate authenticating the player, and/or to authorize the player to play a game on gaming device 114 as desired or required. In one embodiment, the player may “log in” to gaming device 114 by swiping the player reward card or otherwise passing the player reward card through, or inserting the player reward card within, card reader 406. In another embodiment, the player may enter a number or other identifier associated with the player reward card into gaming device 114, through user interface device 312 for example, instead of using card reader 406. In another embodiment, the insertion of the player reward card and player entering the identifier into user interface device 312 may be combined. In yet another embodiment, the player may use a near field communication (NFC) device, such as an NFC device incorporated within communication device 308, to read the player reward card or data representative of the player card.

In one embodiment, barcode scanner 408 is an optical or a magnetic scanner that is optimized to read barcodes on media positioned proximate to scanner 408. For example, barcode scanner 408 may be optimized to read barcodes printed on paper receipts (sometimes referred to as “tickets” or vouchers, not to be confused with game or player tickets that may include player selected patterns, player indicia, and the like) and/or barcodes displayed electronically on a cell phone or tablet computing device. It should be recognized that the barcodes read by barcode scanner 408 may be linear or one-dimensional barcodes, two-dimensional barcodes, or may even include data represented in a form other than a barcode. For example, barcode scanner 408 may read images and/or text indicative of data, such as currency or credits, usable with gaming device 114. Barcode scanner 408 extracts the data from the barcode and transmits the data to processor 304. For example, barcode scanner 408 may scan a paper receipt or voucher that includes an amount of currency or credits usable by the player with a gaming device 114 and may transmit the amount of credits to processor 304. In such an example, barcode scanner 408 may act as a payment input device to receive or read one or more physical items associated with a monetary value. Processor 304 may cause the amount of currency or credits to be added to a currency or credit balance for the player on gaming device 114 or on another suitable device or system. Processor 304 may also cause the amount of currency or credits to be displayed to the player on first display 316 (or on display 310 in embodiments including a single display 310) to inform the player how many credits or currency is available to be used in playing a game.

Printer 410 may be used to print paper receipts (also known as tickets as described above) that indicate an amount of currency or credits available to the player. In many locations, the tickets or receipts may alternatively be referred to as vouchers. Printer 410 may act as a payment output device that enables a player to cash out or withdraw money or credits from gaming device 114 by printing a voucher representative of the money or credits when the player initiates a cash out operation using, for example, user interface 312 of gaming device 114. In one embodiment, printer 410 is a thermal printer that is fed by a roll of paper or any suitable paper stock. In a further embodiment, the roll of paper includes one or more watermarks that are visible when printer 410 has printed the receipt on the paper. Alternatively, printer 410 may print the watermark on the receipt, or may include another security mechanism to facilitate preventing counterfeit receipts from being made. For example, printer 410 may include an image or a code on the receipt that identifies gaming device 114, printer 410, or another component of gaming device 114 along with a time that the receipt was printed. Other suitable security mechanisms may be used as well. It should be recognized that barcode scanner 408 and printer 410 may cooperate such that a security mechanism printed on the receipt may be received and validated by barcode scanner 408, in conjunction with processor 304, for example. Barcode scanner 408 may be located remotely from gaming device 114, such as within a redemption kiosk, a casino cage, or the like. In some embodiments, printer 410 may also print reports indicating the player's win amounts, loss amounts, wager amounts, and/or net win amounts.

Intrusion detection system 412 notifies processor 304 if a case, cabinet, or other housing enclosing components of gaming device 114 is opened or modified without authorization. In one embodiment, intrusion detection system 412 includes a pair of contacts that transmit an electronic signal to processor 304 if the housing of gaming device 114 is opened (e.g., if the opening of the housing separates the contacts). In another embodiment, intrusion detection system 412 may include a light sensor that detects a change in the light within the housing of gaming device 114. Intrusion detection system 412 may also include a key or another mechanism for disabling the transmission of the signal to processor 304 in the event that maintenance or other authorized access to gaming device 114 components is desired.

In one embodiment, intrusion detection system 412 includes a software program (a “monitoring program”) that monitors one or more applications installed on gaming device 114. For example, if gaming device 114 is a cell phone that includes an application for playing the game thereon, the monitoring program may monitor the application to determine whether the application is modified without authorization. In one embodiment, the monitoring program stores a hash value or a digital fingerprint of the application when the application is installed and/or when the application undergoes authorized modification (e.g., if the application is updated or patched). However, if the monitoring program determines that the application has been modified without authorization, the monitoring program may cause a signal or another notification to be transmitted to processor 304. For example, the monitoring program may periodically calculate a new hash value of the application and/or create a new digital fingerprint of the application. The monitoring program then compares the new hash value and/or digital fingerprint to the stored hash value and/or digital fingerprint. If the hash values or fingerprints are different, the monitoring program may determine that the application has been modified without authorization. It should be understood that the hash value, the monitoring program, and/or the digital fingerprint may be generated by any suitable means and may be encrypted for additional security.

In response to the signal or notification from intrusion detection system 412 and/or the modification program, processor 304 may perform one or more actions. For example, processor 304 may alert an administrator within gaming establishment 102 by transmitting a message via communication device 308, may cause audio output device 314 to emit an alarm or another audible alert, may cause first display 316 to display an error or a warning, and/or may disable the application and/or gaming device 114 such that the game is unable to be played on gaming device 114.

In one embodiment, randomization device 414 is an electronic random number generator (RNG) 414 or a permutation generator that may be implemented by a dedicated hardware device with associated embedded software. Alternatively, RNG 414 or the permutation generator may be implemented entirely in software executing on gaming device 114. RNG 414 may be used to randomly determine a game outcome for the game of chance. In one embodiment, RNG 414 or the permutation generator provides house or game draws of between 1 and n numbers, where n may be a suitable number based on the game type selected to be played by the player. RNG 414 or the permutation generator may be programmed via hardware, software, or firmware to provide a particular range of numbers (or other indicia) and numbers of draws for a particular application. For example, in one embodiment of bingo according to the present disclosure, RNG 414 or the permutation generator initially provides 24 randomly generated numbers having values between 1 and 75 for each game. Additional draws or numbers may be provided to play the game to conclusion depending on the particular implementation as described in greater detail herein. In addition, RNG 414 or the permutation generator may be used to randomly select a plurality of player indicia to be used with one or more player cards. In embodiments in which a processor, such as processor 304, is described as randomly selecting indicia, it should be recognized that processor 304 may interface with randomization device 414 or the permutation generator to select the indicia. In other embodiments, processor 304 may include randomization device 414 or the permutation generator, or may execute instructions to perform the functions of randomization device 414 or the permutation generator.

Accounting interface 416 is used to interface with an accounting system, such as accounting system 128, at or connected to a gaming establishment 102. Accounting interface 416 may include or be connected to a network interface, such as communication device 308 for use in communicating gameplay data, player identification information, and/or other data to the accounting system for accounting and/or auditing purposes.

Lighting element 418 may include, for example, one or more LEDs, slot machine candles, fluorescent tubes, and/or any other element that emits light as controlled or directed by processor 304. In one embodiment, lighting element 418 is activated to display light, or one or more lighting patterns, when processor 304 determines that a winning ticket was scanned via card reader 406 or when processor 304 otherwise determines that a ticket is a winning ticket. Lighting elements 418 may also be activated upon receipt of a signal from intrusion detection system 412 (e.g., upon the determination that gaming device 114 has been opened and/or modified without authorization) and/or upon any other suitable determination.

In one embodiment in which gaming device 114 is a kiosk, the kiosk may interface with another gaming device 114 operated by or otherwise associated with the player, such as a cell phone or another mobile device. For example, the kiosk or associated computing device or server may be configured to transmit a result of one or more games of chance to the player's mobile device to notify the player whether one or more player cards or game tickets are winning cards or tickets.

The kiosk may also notify the player that a software application is available to be installed on the player's mobile device. If the player installs the application on the mobile device, for example, the results of the games of chance and/or the determinations of whether the player's card and/or tickets are winners may be automatically transmitted to the application to be displayed to the player. Alternatively, the kiosk or another device (such as local server 110 or WAP server 120) may automatically transmit the results of the games and/or the determinations of the winning cards and/or tickets to the player's mobile device or other device via email, SMS message, MMS message, and/or by any other suitable means. In one embodiment, the kiosk (i.e., processor 304 of the kiosk) or another device (such as local server 110 or WAP server 120) may wait to transmit the results of the games until all of the games for the player's purchased cards or tickets have been completed. Accordingly, if the player purchases player cards or game tickets for a current game and/or one or more future games, the results of the current game and the future games may not be transmitted until all of the future games associated with the player's cards or tickets have been completed.

The player may also view the player cards and/or the game tickets that the player has selected on the player's mobile device or other device, for example, using the application. After the player receives the results of the games and/or the determinations of whether the player's cards and/or tickets are winners, the player may use the mobile device (i.e., the application installed on the mobile device) to receive any winnings from the games and/or to cancel any unplayed games, player cards, and/or game tickets. The winnings may be credited to the player's account, for example, using the mobile device.

In one embodiment, one or more advertisements and/or promotions may be presented to the player via the mobile device or other device (e.g., through the application). For example, after the player has been notified of any winning tickets or player cards, a promotion may be presented to the player on the mobile device that offers a bonus or discount for one or more products or services if the player uses (or redeems) at least a portion of the winnings to purchase the product or service. Alternatively, the promotion may be transmitted along with, or before, the player has been notified of any winning tickets or player cards. The bonus or discount may be restricted to being usable within a predetermined amount of time after the promotion was transmitted to the mobile device, or the bonus or discount may be increased if the player purchases the product or service within the predetermined amount of time. For example, a promotion may be offered to the player in which the player receives a bonus (free) dinner if the player cashes in or redeems a winning ticket at a casino within 24 hours of the promotion being sent to the player's device. As another example, the player may receive bonus credits if the player purchases one or more game tickets for a new game of chance using at least a portion of the winnings.

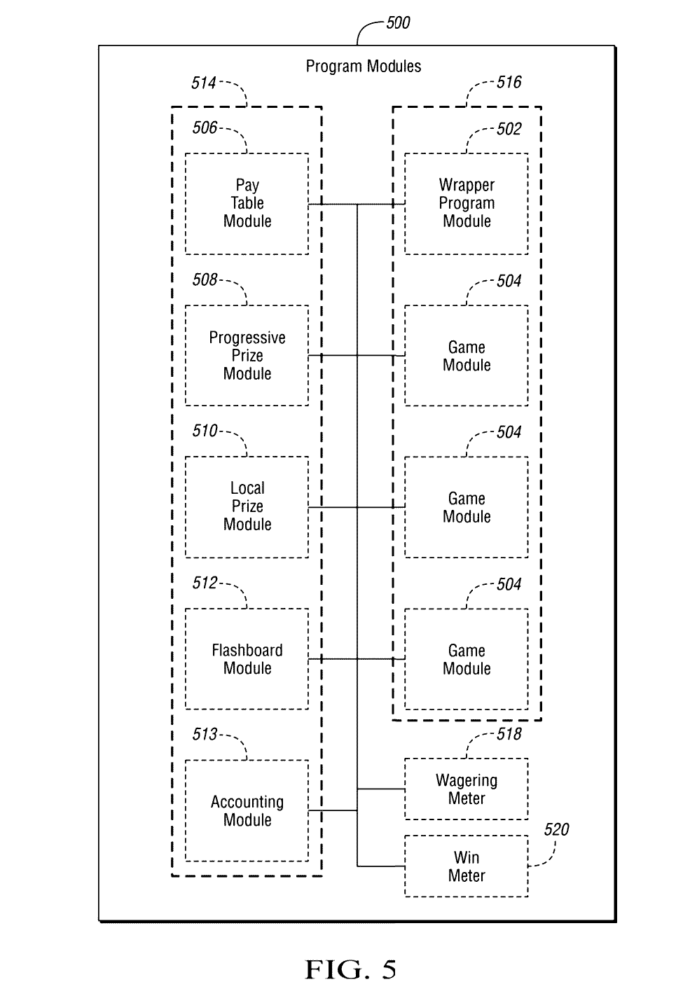

FIG. 5 is a block diagram of a plurality of program modules 500 that may be used with system 100 (shown in FIG. 1) or system 200 (shown in FIG. 2) to administer one or more games of chance, such as bingo or keno. In one embodiment, program modules 500 are installed and/or stored within local server 110, WAP server 120, and/or gaming devices 114. For example, program modules 500 may be stored in memory device 306 of local server 110, WAP server 120, and/or gaming devices 114.

Program modules 500 are firmware and/or software programs or applications that, when executed by processor 304 of local server 110, WAP server 120, and/or gaming device 114, cause processor 304 to perform the functions described herein. In one embodiment, program modules 500 include a wrapper program module 502, a plurality of game modules 504, a pay table module 506, a progressive prize module 508, a local prize module 510, a flashboard module 512, and/or an accounting module 513. A first plurality 514 of program modules 500 may be installed within each local server 110 and/or WAP server 120 and a second plurality 516 of program modules 500 may be installed within each gaming device 114. Program modules 500 may also include a wagering meter 518 and/or a win meter 520 that may be included in first plurality 514 of program modules 500 and/or second plurality 516 of program modules 500. It should be recognized that in embodiments in which the game of chance is administered by gaming device 114 (e.g., when a cell phone or a tablet computing device is used as gaming device 114), some or all of the first plurality 514 of program modules 500 may be incorporated within gaming device 114 and executed by processor 304 of gaming device 114. Alternatively, some or all of the second plurality 516 of program modules 500 may be incorporated within local server 110 and/or WAP server 120. Together, wrapper program module 502, game modules 504, and other program modules 500 that present and/or administer one or more games may be referred to herein as a game application, or an application.

In one embodiment, wrapper program module 502 is used at least in part to provide a graphical user interface (GUI) on first display 316 of gaming device 114 (or on display 310 in embodiments that include a single display). Wrapper program module 502 operates to provide an entry point or a game entry interface for a player to access gaming device 114, and to enable the player to select a game of chance to be played on gaming device 114. For example, the games of chance may be categorized into a plurality of game sizes and a plurality of game variations. Wrapper program module 502 may present the game sizes and the game variations to the player, using first display 316, and may enable the player to select a game to play by selecting a game size and game variation through user interface device 312.

In one embodiment, wrapper program module 502 may present a list of player card sizes (i.e., game sizes or matrices), such as 3×3, 4×4, and 5×5, to the player for selection on first display 316. In addition, wrapper program module 502 may present a list of games or game variations to the player for selection on first display 316. Alternatively, the game size and game variation may be combined into one selectable icon, such as an icon representing a first variation of 3×3 bingo or a second variation of 5×5 bingo. If the player selects a size and variation, wrapper program module 502 calls or branches to a game module 504 that provides the selected game size and variation.

In one embodiment, game modules 504 each provide a game associated with the selected game size and/or game variation to the player using gaming device 114, local server 110, and/or WAP server 120. Accordingly, in one embodiment, each game is provided by a separate game module 504. Alternatively, each game module 504 may provide more than one game to the player.

Pay table module 506 provides a pay table associated with each game such that one or more pay tables may be associated with each game module 504. In one embodiment, pay table module 506 provides a pay table associated with a game when game module 504 requests the pay table and/or when a predetermined event occurs during the game. Pay tables associated with a game may be changed as desired by a game operator by any suitable means. The predetermined event may include, for example, the player selecting a “See Pays” or another icon displayed on first display 316 that represents a request to view the pay table for the game. The predetermined event may also include reaching a point in the game in which the house indicia are matched to the player indicia within a selected pattern to determine whether the player wins a prize.

Progressive prize module 508 may be used to administer aspects of one or more progressive prizes, such as one or more progressive prizes offered to players playing across network 108. For example, progressive prize module 508 may receive information regarding an amount wagered by each player playing a game that has a chance to win the progressive prize. Progressive prize module 508 may allocate a first portion of each wager to a first progressive prize to increase the size of the progressive prize. Progressive prize module 508 may allocate a second portion of each wager to a second progressive prize, and may continue in a similar manner for any additional progressive prizes, if desired or applicable. Accordingly, a plurality of progressive prizes may be provided for each game and may be at least partially funded by each wager.

Local prize module 510 may be used to administer aspects of one or more local prizes, such as one or more prizes that may be won by players playing against each other within a gaming establishment 102. In addition, local prize module 510 may administer aspects of one or more fixed prizes, such as prizes that may be won only by individual players playing on respective gaming devices 114. Accordingly, fixed or individual prizes may be awarded to a player based on the gameplay of the player against randomization device 414 of gaming device 114, rather than based on winning against other players.

In one embodiment, flashboard module 512 may be used to display called bingo numbers or other house indicia within one or more gaming establishments. In another embodiment, flashboard module 512 may be used to display called bingo numbers, keno numbers, or other house indicia on gaming devices 114 themselves, for example, on second display 318 (or on display 310 in embodiments that include a single display) during play of the game. Flashboard module 512 may cause the house indicia to be displayed as a rectangular matrix of spaces (sometimes referred to as a “flashboard”). For bingo games played utilizing 75 numbers or indicia, the letters B, I, N, G, and O may be pre-printed above five vertical columns of the matrix with one letter appearing above each column to assist players in more quickly locating a called number on their card(s). For 75 number bingo games, the numbers printed on the card are commonly arranged as follows: 1 to 15 in the B column, 16 to 30 in the I column, 31 to 45 in the N column, 46 to 60 in the G column, and 61 to 75 in the O column. However, other arrangements of the flashboard may be used instead of the arrangement described herein.

Accounting module 513 may be used to interface with an accounting system, such as accounting system 128, at or connected to a gaming establishment 102. In one embodiment, accounting module 513 is incorporated within, or executed by, accounting interface 416. Any suitable data, such as gameplay data, player identification information, an amount of prizes won by a player, an amount of wagers placed by a player, and/or any other suitable data may be collected and transmitted by accounting module 513.

In one embodiment, computing device 300 may also include a wagering meter 518 and a win meter 520. Wagering meter 518 may be configured to track and/or determine an amount of money or credits wagered by a player of a gaming device 114. Win meter 520 may be configured to track and/or determine an amount of money or credits won by the player at a gaming device 114. While wagering meter 518 and win meter 520 are described as being included within a computing device 300 (e.g., within a gaming device 114 and/or within accounting system 128 in some embodiments), it should be recognized that wagering meter 518 and/or win meter 520 may be included in any suitable device. Wagering meter 518 and win meter 520 may include, for example, one or more mechanical meters, one or more variables, data structures, or software-based counters in a memory (e.g., of memory device 306), and/or any other suitable device or function for tracking money and/or credits.

For keno games played utilizing 80 number or indicia, the numbers may be arranged sequentially in a matrix such that numbers 1-10 appear sequentially in a first row, the numbers 11-20 appear sequentially in a second row below the first row, the numbers 21-30 appear sequentially in a third row below the second row, and so on. It should be recognized that embodiments of keno games having a different number of player indicia (or spots) may be used, such as 49 or 25 spots.

It should be recognized that two or more program modules 500 may be combined together such that the functionality of each program module 500 is incorporated into the combined module. Likewise, each program module 500 may be split into two or more sub-modules that each perform a portion of the functionality of the program module 500 being split. Accordingly, while the above-described program modules 500 are described individually, each may be combined or split into other sub-modules as desired.

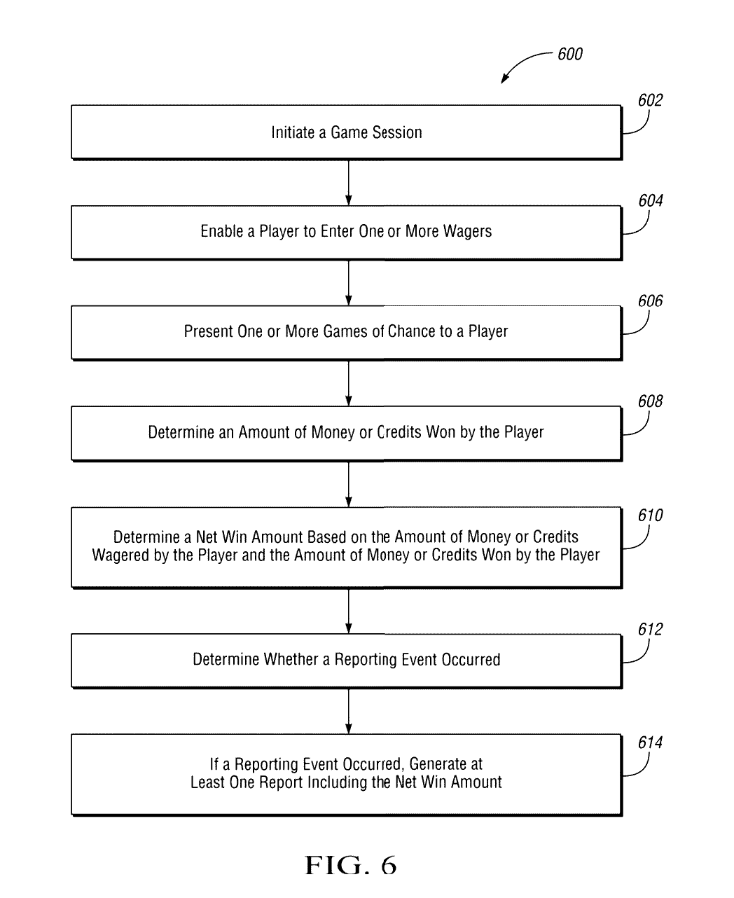

FIG. 6 is a flow diagram of a method 600 of reporting or generating one or more reports based on the winnings of a player at one or more gaming devices 114 (shown in FIG. 1). In one embodiment, method 600 may generate one or more taxable winnings reports that are automatically formatted or optimized for submission to the Internal Revenue Service (IRS) or to another suitable regulatory agency. For example, method 600 may generate one or more W-2G forms as the taxable winnings reports. Alternatively, method 600 may generate any other suitable report based on the gameplay of the player at one or more gaming devices 114 in accordance with the embodiments described herein.

In one embodiment, method 600 is performed by one or more processors 304 of one or more computing devices 300 executing instructions stored within one or more memories, such as memory device 306. For example, method 600 may be implemented by processor 304 of a gaming device 114, WAP server 120, local server 110, accounting system 128, and/or by any other suitable device.

During operation of method 600, a game session may be initiated 602 on a gaming device 114. The game session may last, for example, until the player cashes out of gaming device 114 or otherwise ends play at gaming device 114. The player is enabled 604 to enter one or more wagers for one or more games of chance. For example, the player may enter one or more wagers through user interface device 312 of gaming device 114. The wagers entered by the player may be tracked by gaming device 114, by accounting system 128, and/or by any other suitable device or system. For example, the amount of money or credits wagered by the player may be tracked by a wagering meter included within gaming device 114, accounting system 128, and/or any other suitable system or device.

During the game session, one or more games of chance are presented 606 to the player on gaming device 114. The games of chance may include, without limitation, video reel slots, video poker, sports betting or sport book games, bingo or bingo-related games, keno or keno-related games, and/or any other games of chance. The game or games may be displayed to the player, for example, on one or more displays 310 of gaming device 114.

In one embodiment, an amount of money or credits won by the player during the game or games of chance is determined 608. The determination of the amount won may be done by gaming device 114, accounting system 128, and/or any other suitable system or device. For example, if the player has won individual jackpots of $500, $2500, and $1000, then gaming device 114, accounting system 128, and/or any other suitable system or device may determine that the player has won a total of $4000. In one embodiment, the amount of money or credits won by the player may be tracked by a win meter included within gaming device 114, accounting system 128, and/or any other suitable system or device. It should be recognized that in this embodiment, the total amount won by the player during the course of the game session is tracked and determined. Alternatively, the amount of money or credits won by the player may be tracked for each individual game, period of game play, and/or may be tracked and determined for any other suitable period of time.

A net win amount may also be determined 610 based on the amount of money or credits wagered by the player and the amount of money or credits won by the player. The net win amount may be determined by gaming device 114, accounting system 128, and/or any other suitable system or device. In one embodiment, the net win amount is determined to be the total amount of money or credits won by the player minus the total amount of money or credits wagered by the player. For example, if the player won a total of $4,000 during the game session yet wagered $2,500, the net win amount would be $1,500.

It should be recognized that the amount of money or credits wagered by the player, the amount of money or credits won by the player, and/or the net win amount may be tracked and determined for different periods of time (hereinafter referred to as a “reporting periods”). For example, the amounts may be tracked daily, monthly, and yearly, or may be tracked for any other suitable amounts of time. The reporting period may alternatively be defined as the timeframe of the game session, the amount of time the player has played games of chance on various gaming devices 114 within a gaming establishment 102, and/or any other suitable timeframe.

In one embodiment, gaming device 114, accounting system 128, and/or any other suitable device may determine 612 whether a reporting event has occurred. The reporting event may include, without limitation, a determination that the player has selected a “cash out” or similar option on gaming device 114, the player has moved to another gaming device 114, the player has moved to another gaming establishment 102, a predetermined amount of time has elapsed (such as 1 day, 1 month, or 1 year), a new day has begun, and/or any other suitable event. In one embodiment, the reporting event may include a determination that the net win amount exceeds or is equal to a predetermined threshold, such as a taxable winnings threshold established by the IRS or another suitable regulatory agency. Alternatively, the reporting event may include a determination that one or more wins of the player, taken individually or as a total, meets or exceeds a predetermined threshold. The reporting event may alternatively include a combination of events. For example, the reporting event may include determining that 1) the net win amount (or other win amount) is equal to or exceeds the predetermined threshold and 2) the player cashes out from gaming device or a predetermined amount of time has elapsed (e.g., 1 day, 1 month, or 1 year). A report may also include the win/loss by the player or loss by the player.

If a reporting event has occurred, at least one report including the net win amount is generated 614 by gaming device 114, accounting system 128, and/or by any other suitable system or device and may include both positive and negative win or won amounts. The report may be automatically formatted or optimized for reporting the net win amount and/or other win amounts or wagers to the IRS (e.g., on a W-2G form) or to another regulatory agency. In one embodiment, a single report is generated that includes the net win amount for the gameplay occurring during the reporting period (e.g., 1 day, 1 month, 1 year, or the timeframe of the gaming session). The report may additionally or alternatively include a listing of all wins of the player, all wins that exceeds a predetermined threshold (either taken individually or as a total amount of wins), and/or the amount of money that the player has wagered. The report may also include the net win amount minus each win amount that has been reported separately (e.g., minus each win amount that has met or exceeded the predetermined threshold).

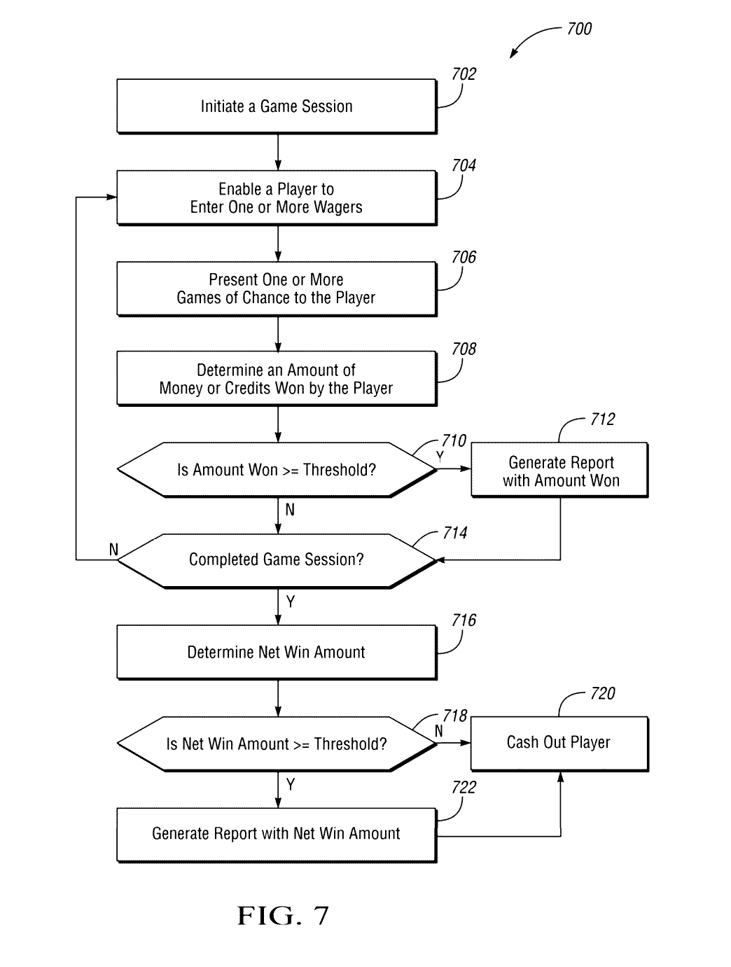

FIG. 7 is a flow diagram of a method 700 of reporting or generating one or more reports based on the winnings of a player at one or more gaming devices 114 (shown in FIG. 1). In one embodiment, method 700 may generate one or more taxable winnings reports that are automatically formatted or optimized for submission to the Internal Revenue Service (IRS) or to another suitable regulatory agency. For example, method 700 may generate one or more W-2G forms as the taxable winnings reports. Alternatively, method 700 may generate any other suitable report based on the gameplay of the player at one or more gaming devices 114 in accordance with the embodiments described herein.

In one embodiment, method 700 is performed by one or more processors 304 of one or more computing devices 300 executing instructions stored within one or more memories, such as memory device 306. For example, method 700 may be implemented by processor 304 of a gaming device 114, WAP server 120, local server 110, accounting system 128, and/or by any other suitable device.

During operation of method 700, a game session may be initiated 702 on a gaming device 114. The game session may last, for example, until the player cashes out of gaming device 114 or otherwise ends play at gaming device 114. The player is enabled 704 to enter one or more wagers for one or more games of chance. For example, the player may enter one or more wagers through user interface device 312 of gaming device 114. The wagers entered by the player may be tracked by gaming device 114, by accounting system 128, and/or by any other suitable system or device. For example, the amount of money or credits wagered by the player may be tracked by a wagering meter included within gaming device 114, accounting system 128, and/or any other suitable system or device.

During the game session, one or more games of chance are presented 706 to the player on gaming device 114. The games of chance may include, without limitation, video reel slots, video poker, sports betting or sport book games, bingo or bingo-related games, keno or keno-related games, and/or any other games of chance. The game or games may be displayed to the player, for example, on one or more displays 310 of gaming device 114.

In one embodiment, an amount of money or credits won by the player during the game or games of chance is determined 708. The determination of the amount won may be done by gaming device 114, accounting system 128, and/or any other suitable system or device. For example, if the player has won individual jackpots of $1,500, $2,500, and $1,000, then gaming device 114, accounting system 128, and/or any other suitable system or device may determine that the player has won a total of $5,000. As another example, if the player's aggregate win of both reportable and non-reportable wins is $1,731 but the player has a lost a total of $1,981, the player has an aggregate win of −$250. In one embodiment, the amount of money or credits won by the player may be tracked by a win meter included within gaming device 114, accounting system 128, and/or any other suitable system or device. It should be recognized that in this embodiment, the total amount won by the player during the course of the game session is tracked and determined. Alternatively, the amount of money or credits won by the player may be tracked for each individual game, or may be tracked and determined for any other suitable period of time.

Gaming device 114, accounting system 128, and/or any other suitable system or device determines 710 whether the amount of money or credits won by the player is equal to or exceeds a predetermined win reporting threshold. In one embodiment, the predetermined win reporting threshold may be a threshold set by a regulatory agency such as the IRS. Alternatively, the win reporting threshold may be any suitable value and either a positive or negative value.

If the amount won is greater than or equal to the predetermined win reporting threshold, a report with the amount of money or credits won by the player is generated 712 by gaming device 114, accounting system 128, and/or any other suitable system or device. The report may be automatically formatted or optimized for reporting the amount won to the IRS (e.g., on a W-2G form) or to another regulatory agency. In one embodiment, a separate report is generated 712 for each jackpot or prize won that is equal to or that exceeds the predetermined win reporting threshold. Alternatively, a single report may be generated 712 that includes or lists all wins that exceed or are equal to the predetermined win reporting threshold during a gaming session or during another suitable timeframe. The single report may include an itemized listing of each win or loss that equals or exceeds the win reporting threshold, if one exists, and/or may include a total sum of all wins that equal or exceed the threshold.

If the player is determined 714 to have not completed the game session (e.g., if the player has not input a request to cash out of gaming device 114), the player is enabled 704 to enter one or more new wagers for one or more new games. However, if the player is determined 714 to have completed the game session, a net win amount is determined 716 for the player based on the amount of money or credits wagered by the player and the amount of money or credits won by the player during the game session or during another suitable timeframe. In one embodiment, the net win amount is determined to be the total amount of money or credits won by the player minus the total amount of money or credits wagered by the player. The net win amount may be determined 716 by gaming device 114, accounting system 128, and/or any other suitable system or device. For example, if the player won a total of $4,000 during the game session yet wagered $2,500, the net win amount would be $1,500. In another case, if a player has won a total of $4,000 during a session yet wagered $5,500, the net win amount would be $1,500. It is understood that any of the embodiments described herein that refer to the win or amount won by the player may include both positive and negative values either individually or in the aggregate.

It should be recognized that the amount of money or credits wagered by the player, the amount of money or credits won by the player, and/or the net win amount may be tracked and determined for different reporting periods. For example, the amounts may be tracked daily, monthly, and yearly, or may be tracked for any other suitable amounts of time. The reporting period may alternatively be defined as the timeframe of the game session, the amount of time the player has played games of chance on various gaming devices 114 within a gaming establishment 102, and/or any other suitable timeframe.

Gaming device 114, accounting system 128, and/or any other suitable system or device may determine 718 whether the net win amount is equal to or exceeds a predetermined net win reporting threshold. It should be recognized that a reporting threshold may include any number and may be triggered by any waging activity whatsoever. In one embodiment, the net win reporting threshold is the same as the win reporting threshold described above. Alternatively, the net win reporting threshold may be higher or lower than the win reporting threshold. The net win reporting threshold may be set by the IRS, by another suitable regulatory agency, or by any other suitable entity. If the net win amount is less than the net win reporting threshold, the player may be “cashed out” 720 at gaming device 114 and method may end.

However, if the net win amount is equal to or greater than the net win reporting threshold, at least one report including the net win amount is generated 722 by gaming device 114, accounting system 128, and/or any other suitable device. The report may be automatically formatted or optimized for reporting the net win amount and/or other win amounts or wagers to the IRS or to another regulatory agency. In one embodiment, a single report is generated 722 that includes the net win amount for the gameplay occurring during the reporting period (e.g., 1 day, 1 month, 1 year, or the timeframe of the gaming session).

In one embodiment, a separate report with the net win amount is generated 722 in addition to each report generated 712 as a result of individual wins that exceed the win reporting threshold described above. In such an embodiment, the report that includes the net win amount may include the net win amount regardless of any jackpots or prizes included within the report or reports for the individual wins. For example, if the win reporting threshold and the net win reporting thresholds are both equal to $1200, and the player wins a $1300 prize and has an overall net win (including the $1300 prize) of $2000, the player may receive a report showing a net win of $2000 in addition to the report showing the $1300 prize. In such an embodiment, the player may have the burden of reconciling the report of the individual $1300 prize and the report of the net win of $2000 (that also incorporates the $1300 win) with the IRS. To facilitate reconciling these reports, the reports may include the serial number or other identifying characteristics of gaming device 114 and/or the game session.

Alternatively, the report with the net win amount may include the net win amount minus any jackpots or prizes included within the report or reports for the individual wins. For example, if the win reporting threshold and the net win reporting thresholds are both equal to $1200, and the player wins a $1300 prize and has an overall net win (including the $1300 prize) of $2000, the player may receive a report showing a net win of $700 ($2000-$1300) in addition to the report showing the $1300 prize.

After any reports have been generated (if applicable), gaming device 114 or another suitable device or system cashes out 720 the player and method 700 may end. Accordingly, the player may receive actual money, credits, vouchers, or any other suitable representation of the money or credits receivable by the player as a result of the player's gameplay on gaming device 114.

In one embodiment, the reports generated by method 600 and/or method 700 are automatically transmitted to the IRS or another suitable regulatory agency. The player may also receive a copy of each report generated as described herein.

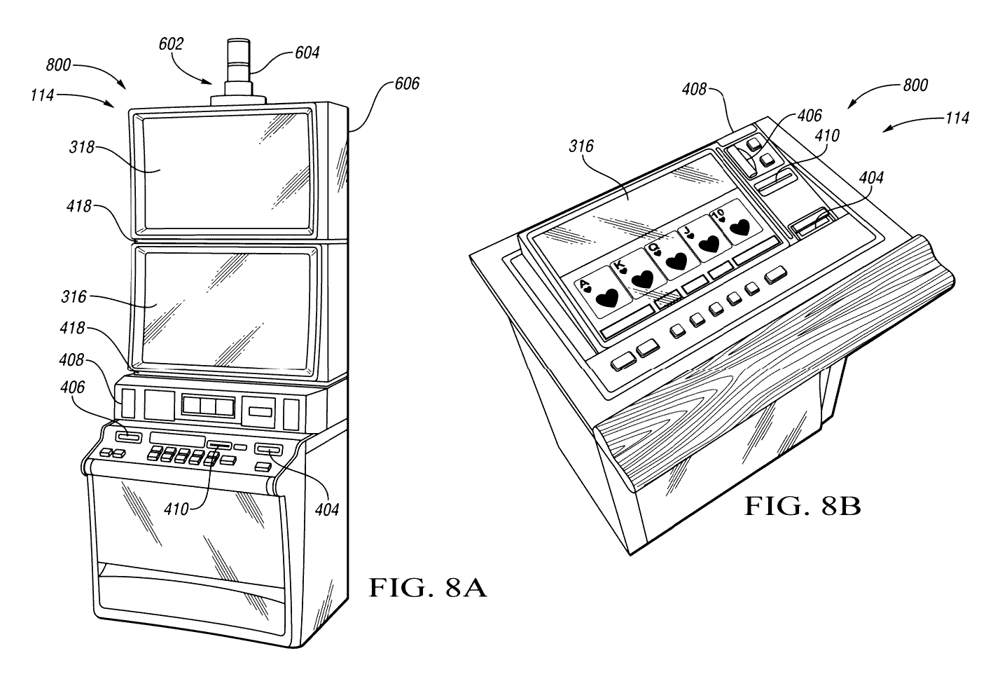

FIG. 8A is an illustration of an exemplary electronic gaming machine (EGM) 800 configured as a stand-alone kiosk (also referred to as “kiosk 800”) that may be used with the systems described herein. In one embodiment, EGM 800 is a gaming device 114. FIG. 8B is an illustration of EGM 800 configured as a bar top machine described herein. In bar top machine embodiments, EGMs 800 are placed at a slight horizontal angle to facilitate play as illustrated in FIG. 8B, for example.

As illustrated in FIGS. 8A and 8B, EGM 800 may include, for example, a processor 304, a memory device 306, a communication device 308, an audio output device 314 (none shown in FIG. 8A or 8B), a first display 316, and/or a second display 318 as described above with reference to FIG. 3. In addition, EGM 800 may include a bill acceptor 404 (also known as a bill validator), a card reader 406, a barcode scanner 408, a printer 410, a randomization device 414 (not shown in FIG. 8A or 8B), and/or one or more lighting elements 418 as described above with reference to FIG. 4. EGM 800 may also include one or more program modules 500 described in FIG. 5, such as wagering meter 518 and/or win meter 520.

In one embodiment, EGM 800 may be used to determine a net win amount of a player playing a game of chance. For example, wagering meter 518 may output a signal or data representative of an amount of money or credits wagered by the player. Win meter 520 of EGM 800 may output a signal or value representative of an amount of money or credits won by the player. The amounts wagered and won may be accumulated in memory device 306 over a predetermined period of time, such as during the time the player plays games on EGM 800, during a day, during a year, and/or during any other suitable time period. When a reporting event occurs or at the end of the predetermined period of time, EGM 800 may generate a report that identifies the amounts of money or credits wagered, the amounts of money or credits won or lost, and/or any other suitable information. Alternatively, another computing device, such as local server 110, player reward server 112, or WAP server 120 stores the amounts wagered, won, and/or lost during the predetermined period of time. In one embodiment, the computing device may then generate the report after the predetermined period of time has elapsed or when a reporting event occurs.

In one embodiment, EGM 800 or a server or system connected thereto, such as local server 110, WAP server 120, or accounting system 128, requires the player to input identification into EGM 800, such as through card reader 406, barcode scanner 408, and/or user interface device 312 before playing a game on EGM 800. For example, EGM 800 may display a prompt for the player to insert, scan, or enter the details of the player's social security card or other taxpayer identification card or number into EGM 800. EGM 800 may use the player's taxpayer identification card or number to generate the report, such as a W-2G form for submission to the IRS.

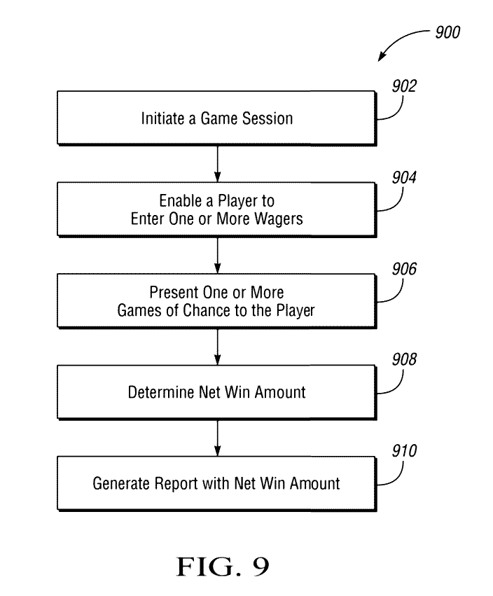

FIG. 9 is a flow diagram of a method 900 of reporting or generating one or more reports based on the winnings of a player at one or more gaming devices 114 (shown in FIG. 1). In one embodiment, method 900 may generate one or more taxable winnings reports that are automatically formatted or optimized for submission to the IRS or to another suitable regulatory agency. For example, method 900 may generate one or more W-2G forms as the taxable winnings reports. Alternatively, method 900 may generate any other suitable report based on the gameplay of the player at one or more gaming devices 114 in accordance with the embodiments described herein.

In one embodiment, method 900 is performed by one or more processors 304 of one or more computing devices 300 executing instructions stored within one or more memories, such as memory device 306. For example, method 900 may be implemented by processor 304 of a gaming device 114, WAP server 120, local server 110, accounting system 128, and/or by any other suitable device.

During operation of method 900, a game session may be initiated 902 on a gaming device 114. The game session may last, for example, until the player cashes out of gaming device 114 or otherwise ends play at gaming device 114. The player is enabled 904 to enter one or more wagers for one or more games of chance. For example, the player may enter one or more wagers through user interface device 312 of gaming device 114. The wagers entered by the player may be tracked by gaming device 114, by accounting system 128, and/or by any other suitable device or system. For example, the amount of money or credits wagered by the player may be tracked by a wagering meter included within gaming device 114, accounting system 128, and/or any other suitable system or device.

During the game session, one or more games of chance are presented 906 to the player on gaming device 114. The games of chance may include, without limitation, video reel slots, video poker, sports betting or sport book games, bingo or bingo-related games, keno or keno-related games, and/or any other games of chance. The game or games may be displayed to the player, for example, on one or more displays 310 of gaming device 114.

In one embodiment, a net win amount may be determined 908 based on the amount of money or credits wagered by the player and the amount of money or credits won by the player. The net win amount may be determined by gaming device 114, accounting system 128, and/or any other suitable system or device. In one embodiment, the net win amount is determined to be the total amount of money or credits won by the player minus the total amount of money or credits wagered by the player. For example, if the player won a total of $4000 during the game session yet wagered $2500, the net win amount would be $1500.

It should be recognized that the amount of money or credits wagered by the player, the amount of money or credits won by the player, and/or the net win amount may be tracked and determined for different periods of time (i.e., during different reporting periods). For example, the amounts may be tracked daily, monthly, and yearly, or may be tracked for any other suitable amounts of time. The reporting period may alternatively be defined as the timeframe of the game session, the amount of time the player has played games of chance on various gaming devices 114 within a gaming establishment 102, and/or any other suitable timeframe.

At least one report including the net win amount is generated 910 by gaming device 114, accounting system 128, and/or by any other suitable system or device. The report may be automatically formatted or optimized for reporting the net win amount and/or other win amounts or wagers to the IRS (e.g., on a W-2G form) or to another regulatory agency. In one embodiment, a single report is generated 910 that includes the net win amount for the gameplay occurring during the reporting period (e.g., 1 day, 1 month, 1 year, or the timeframe of the gaming session). Any reports as described herein may include various information that is required by the IRS or other regulatory agencies and may include information not specifically required by the IRS or other regulatory agencies.

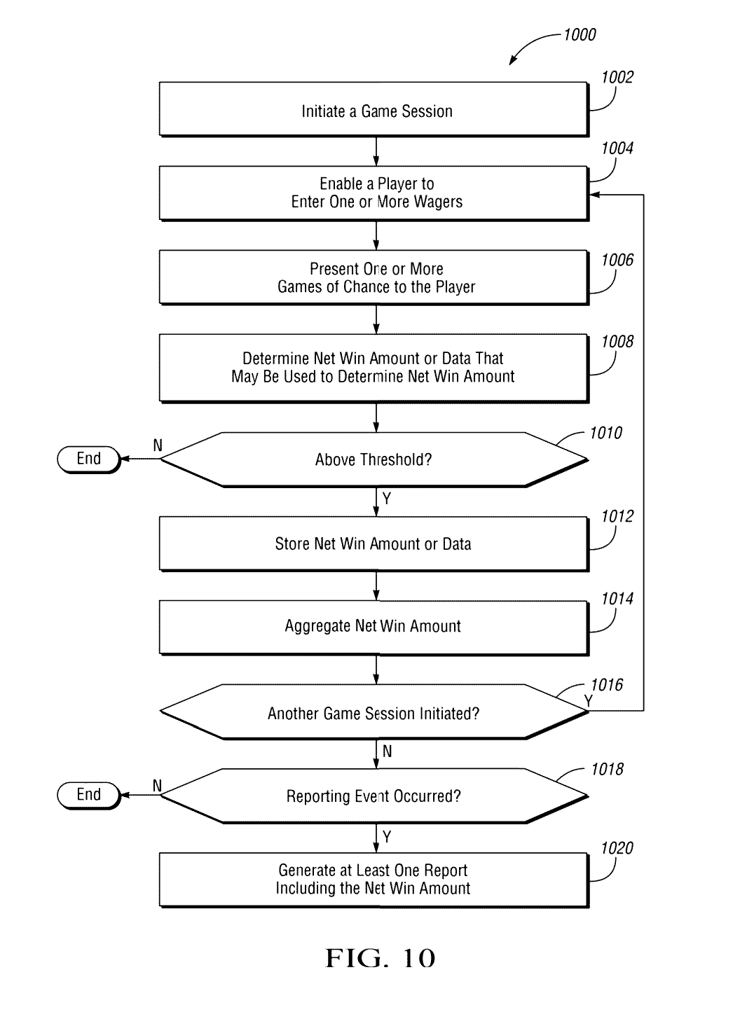

FIG. 10 is a flow diagram of a method 1000 of reporting or generating one or more reports based on the winnings of a player at one or more gaming devices 114 (shown in FIG. 1). In one embodiment, method 1000 may generate one or more taxable winnings reports that are automatically formatted or optimized for submission to the IRS or to another suitable regulatory agency. For example, method 1000 may generate one or more W-2G forms as the taxable winnings reports. Alternatively, method 1000 may generate any other suitable report based on the gameplay of the player at one or more gaming devices 114 in accordance with the embodiments described herein.

In one embodiment, method 1000 is performed by one or more processors 304 of one or more computing devices 300 executing instructions stored within one or more memories, such as memory device 306. For example, method 1000 may be implemented by processor 304 of a gaming device 114, WAP server 120, local server 110, accounting system 128, and/or by any other suitable device.

During operation of method 1000, a game session may be initiated 1002 on a gaming device 114. The game session may last, for example, until the player cashes out of gaming device 114 or otherwise ends play at gaming device 114. The player is enabled 1004 to enter one or more wagers for one or more games of chance. For example, the player may enter one or more wagers through user interface device 312 of gaming device 114. The wagers entered by the player may be tracked by gaming device 114, by accounting system 128, and/or by any other suitable system or device. For example, the amount of money or credits wagered by the player may be tracked by a wagering meter included within gaming device 114, accounting system 128, and/or any other suitable system or device.

During the game session, one or more games of chance are presented 1006 to the player on gaming device 114. The games of chance may include, without limitation, video reel slots, video poker, sports betting or sport book games, bingo or bingo-related games, keno or keno-related games, and/or any other games of chance. The game or games may be displayed to the player, for example, on one or more displays 310 of gaming device 114.

In one embodiment, a net win amount of money or credits won by the player during the game or games of chance is determined 1008. In one embodiment, the net win amount is determined to be the total amount of money or credits won by the player minus the total amount of money or credits wagered by the player. The net win amount may be determined 1008 by gaming device 114, accounting system 128, and/or any other suitable system or device. For example, if the player won a total of $4000 during the game session yet wagered $2500, the net win amount would be $1500. In one embodiment, the amount of money or credits won by the player may be tracked by a win meter included within gaming device 114, accounting system 128, and/or any other suitable system or device. It should be recognized that in this embodiment, the net win amount of the player during the course of the game session is tracked and determined. Alternatively, the net win amount of the player may be tracked for each individual game, or may be tracked and determined for any other suitable reporting period such as a calendar year. It should be recognized that any embodiments may generate reports, period by period, in which case the reports may need to be reconciled or a net report may be generated wherein the current report supersedes previous reports by reconciling past activities so a player or gaming establishment only needs the last report generated. It should be recognized that both reconciled and non-reconciled reports may be used in combination.

Additionally or alternatively, data that is usable to obtain the net win amount (hereinafter referred to as the “predicate data”) is determined 1008. For example, the amount of money or credits wagered, won, and/or lost may be determined 1008 for each game and/or game session. If the net win amount is not determined at this step, the net win amount may be determined at a later time, such as at or before a report is generated.

Gaming device 114, accounting system 128, and/or any other suitable system or device determines 1010 whether the net win amount or the predicate data of the player is equal to or exceeds a predetermined reporting threshold. For example, the predicate data of the amount won in a game may be compared to the reporting threshold to determine whether the amount won is equal to or exceeds the threshold. In one embodiment, the predetermined reporting threshold may be a threshold set by a regulatory agency such as the IRS. Alternatively, the win reporting threshold may be any suitable value.

If the net win amount or the predicate data is less than the predetermined reporting threshold, no action may need to be taken and method 1000 ends. However, if the net win amount or the predicate data is greater than or equal to the predetermined reporting threshold, the net win amount is stored 1012 in memory device 306 of gaming device 114, accounting system 128, local server 110, and/or WAP server 120, and/or in another suitable memory. If the net win amount was not determined earlier in step 1008, the net win amount is determined from the predicate data and is stored 1012 in memory device 306 or in another suitable memory.

In one embodiment, the net win amount stored 1012 in memory is aggregated 1014 with any previously stored net win amounts. The aggregation 1014 may be performed over the course of a reporting period (e.g., during a calendar year, during a day, etc.) or may be performed over the course of any other suitable period.

If the player is determined 1016 to have initiated another game session, the player is enabled 1004 to enter one or more new wagers for one or more new games and method 1000 continues as set forth above. However, if the player has not initiated a new game session, gaming device 114, accounting system 128, and/or any other suitable system or device determines 1018 whether a reporting event has occurred. If a reporting event has occurred, at least one report is generated 1020 that includes the net win amount of the player. The report may be automatically formatted or optimized for reporting the net win amount and/or other win amounts or wagers to the IRS or to another regulatory agency. In one embodiment, a single report is generated 1022 that includes the net win amount for the gameplay occurring during the reporting period (e.g., 1 day, 1 month, 1 year, or the timeframe of the gaming session).

In one embodiment, the net win amount may be aggregated 1014 with any previously stored net win amounts after another game session has been initiated 1016 instead of being aggregated 1014 after the net win amount is stored in memory. In any embodiments, the net win or net amount won may include any desired winning event such as any or only one winning event over the reporting threshold, all winning events, all losses or any combination thereof.

As described above, the reporting event may include, without limitation, a determination that the player has selected a “cash out” or similar option on gaming device 114, the player has moved to another gaming device 114, the player has moved to another gaming establishment 102, a predetermined amount of time has elapsed (such as 1 day, 1 month, or 1 year), a new day has begun, and/or any other suitable event. The reporting event may alternatively include a combination of events. For example, the reporting event may include determining that 1) the net win amount is equal to or exceeds the predetermined reporting threshold or another threshold and 2) the player cashes out from gaming device or a predetermined amount of time has elapsed (e.g., 1 day, 1 month, or 1 year)

In one embodiment, the report with the net win amount may also include a listing of each individual win that the player has received as well as each wager that the player has entered. Alternatively, the report may include the net win amount as well as a listing of the total amount the player has won during each day (or other suitable period) and the total amount the player has wagered during each day (or other suitable period). For example, the report may include the net win amount of the player during a calendar year as well as an optional listing of the total amounts wagered and won during each day, each month, and/or the entire year. To facilitate reconciling these reports, the reports may include the serial number or other identifying characteristics of gaming device 114 and/or the game session and may include gaming establishments information such as establishments name, address, phone number, EIN or the like.

After any reports have been generated (if applicable), gaming device 114 or another suitable device or system cashes out 1020 the player and method 1000 may end. Accordingly, the player may receive actual money, credits, vouchers, or any other suitable representation of the money or credits receivable by the player as a result of the player's gameplay on gaming device 114.

In one embodiment, the reports generated by method 900 and/or method 1000 are automatically transmitted to the IRS or another suitable regulatory agency. The player may also receive a copy of each report generated as described herein.

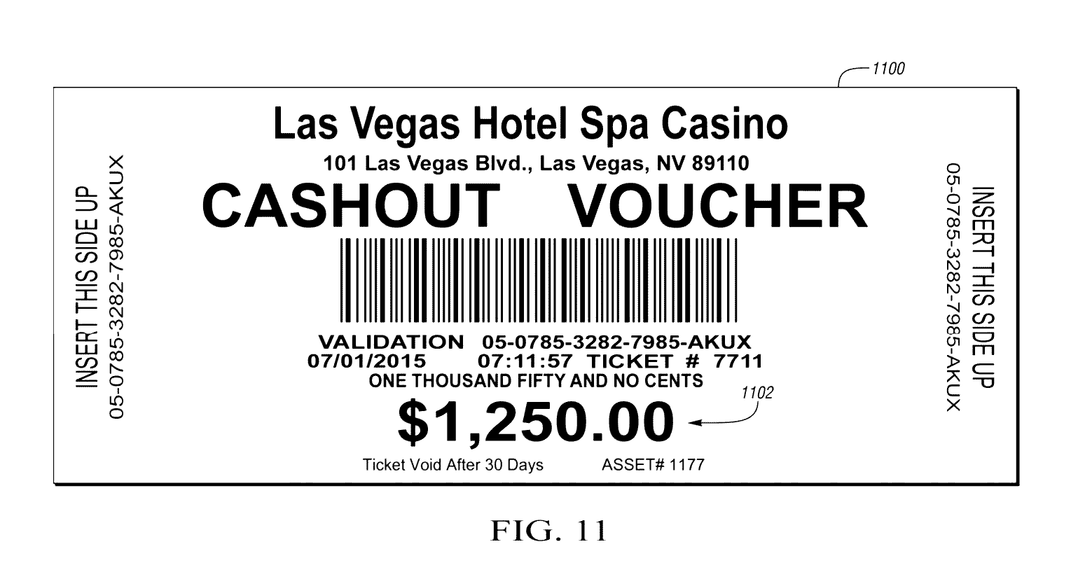

FIG. 11 illustrates an exemplary ticket or voucher 1100 that may be issued to a player when the player cashes out of a gaming device 114, for example.

In one embodiment, if a player cashes out of gaming device 114 after playing a game of chance, gaming device 114 may print or otherwise dispense voucher 1100 to the player. Alternatively, if the player plays a table game, a sport betting game, or the like, a separate device, such as a dealer terminal, a POS terminal, a cash-out station, a printer in a casino cage, and/or another suitable device may print or otherwise dispense voucher 1100.

In one embodiment, voucher 1100 may include a win amount 1102 that reflects an amount of money that the player has won. In one embodiment, win amount 1102 is a net win amount that identifies the total amount of winnings of the player minus the total amount of money wagered by the player. Alternatively, win amount 1102 may only identify the total amount of winnings (in gross) of the player regardless of how much money the player has wagered.

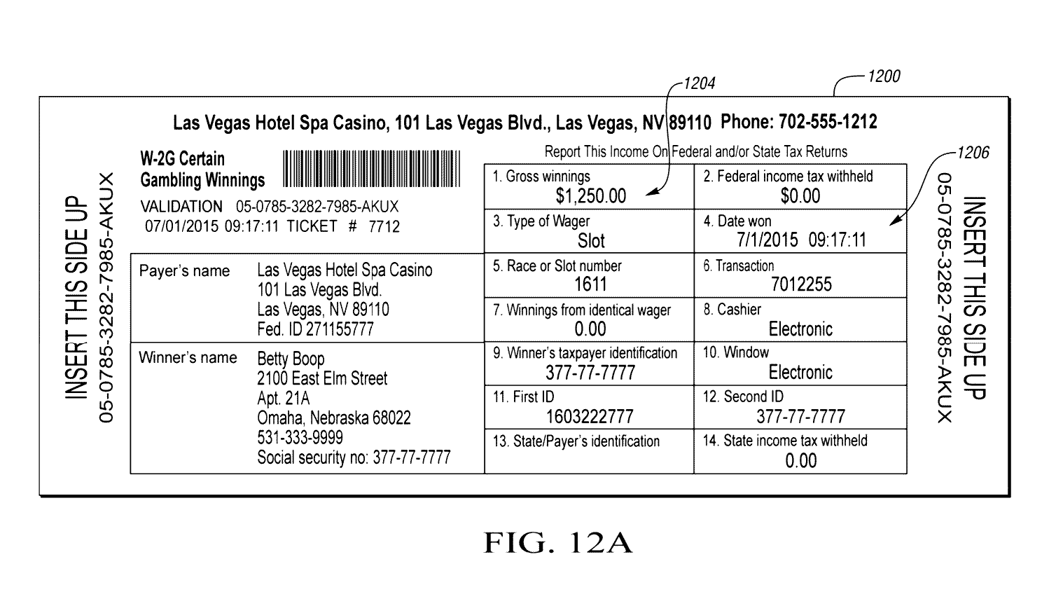

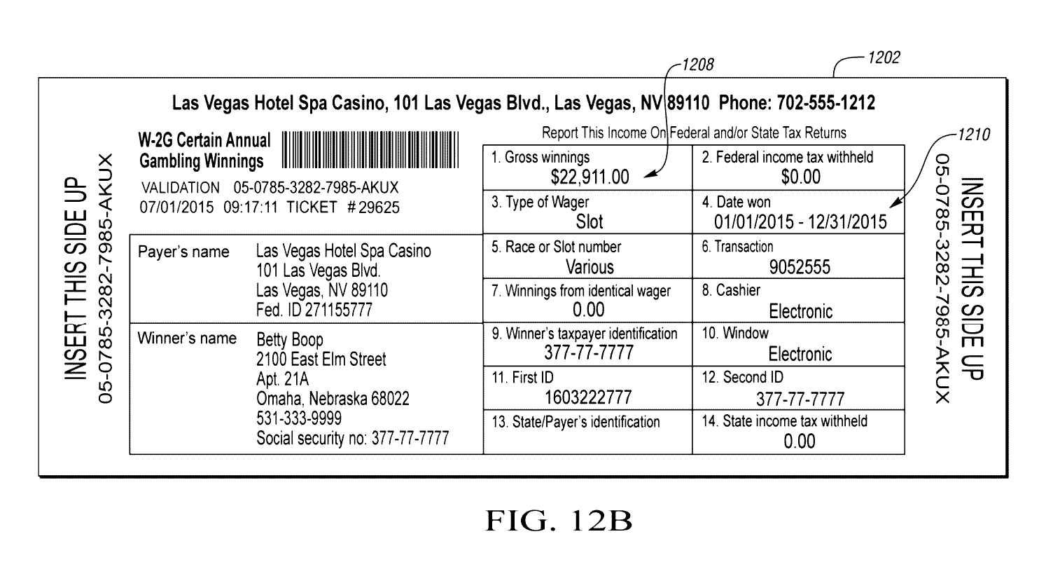

FIG. 12A illustrates an exemplary report 1200 that may be generated for a player after playing a game of chance. FIG. 12B illustrates another exemplary report 1202 that may be generated for a player after playing a game of chance. In one embodiment, reports 1200 and 1202 are W-2G forms that are formatted for submission to the IRS. Alternatively, reports 1200 and 1202 are for the player's own records and may be usable by the player to fill out one or more reporting forms to the IRS.

Referring to FIG. 12A, report 1200 may include a win amount 1204 for a reporting period 1206. In one embodiment, win amount 1204 is a net win amount that identifies the total amount of winnings of the player has won during reporting period 1206 minus the total amount of money wagered by the player during reporting period 1206. Alternatively, win amount 1204 identifies the total amount of winnings the player has won during reporting period 1206. In the example shown in FIG. 12A, reporting period 1206 is the amount of time the player has played one or more games of chance on gaming device 114. However, it should be recognized that reporting period 1206 may be any suitable period as described above.

Referring to FIG. 12B, report 1202 may include a win amount 1208 for a reporting period 1210. In one embodiment, win amount 1208 is a net win amount that identifies the total amount of winnings of the player has won during reporting period 1210 minus the total amount of money wagered by the player during reporting period 1210. Alternatively, win amount 1208 identifies the total amount of winnings the player has won during reporting period 1210. In the example shown in FIG. 12B, reporting period 1210 is the amount of time the player has played one or more games of chance on gaming device 114 within a calendar year. However, it should be recognized that reporting period 1210 may be any suitable period as described above.

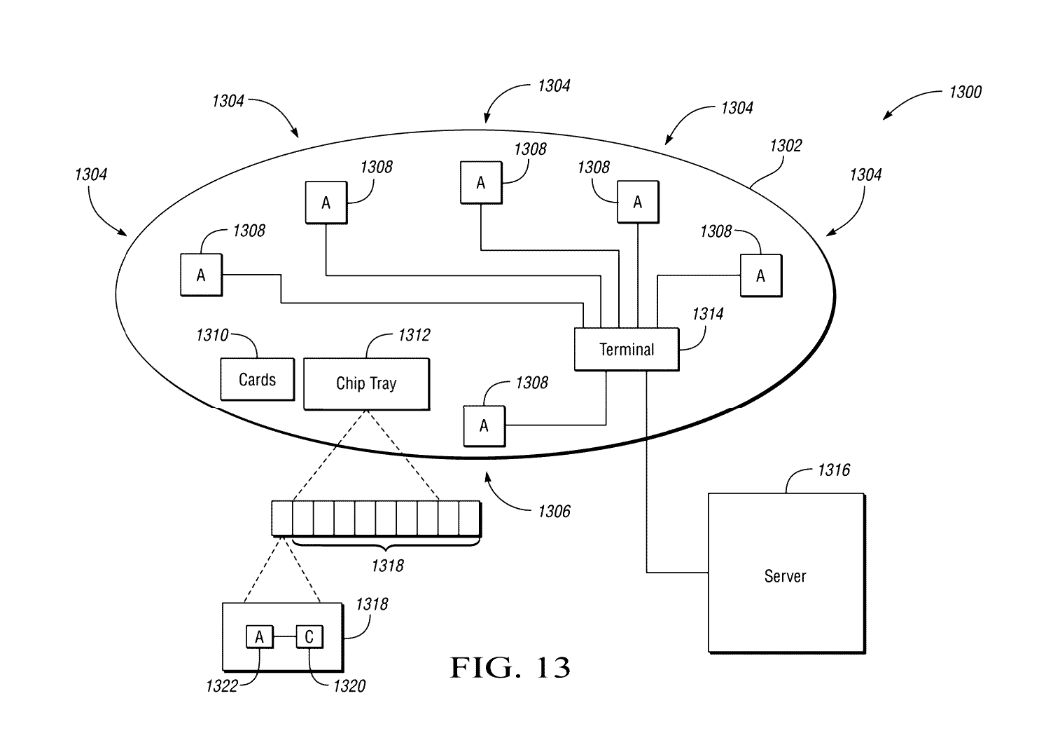

FIG. 13 is a block diagram of an exemplary system 1300 for administering a game of chance. In one embodiment, system 1300 may administer a table game of chance, such as a blackjack game, a poker game, a baccarat game, or the like. While the following embodiments are described with respect to table games having cards and chips, it should be recognized that any suitable table game may be provided in accordance with the embodiments described herein.

In one embodiment, system 1300 includes a table 1302 having a plurality of player positions 1304 that each allows a respective player to play the game. A dealer position 1306 may also be included to enable a dealer or other personnel to facilitate and/or administer the game. Table 1302 may also include one or more table antennas 1308, a plurality of cards 1310, a chip tray 1312, and/or a dealer terminal 1314. In addition, one or more servers 1316 or other suitable computing devices 300 may be communicatively coupled to dealer terminal 1314 and/or table antennas 1308.

Each player position 1304 enables a player to sit or stand at table 1302 to play the game. In one embodiment, each player position 1304 includes a table antenna 1308 associated therewith for reading radio frequency identification (RFID) or other suitable tags of chips, player reward cards, and/or other game components at or near each player position 1304. For example, a respective table antenna 1308 may be positioned underneath table 1302, attached to an underside of table 1302, or integrated within table 1302 at or near each player position 1304. Alternatively, a single table antenna 1308 may be positioned underneath table 1302, attached to an underside of table 1302, or integrated within table 1302 for reading RFID or other suitable tags of chips, player reward cards, and/or other game components at or near all player positions 1304 and/or at other portions of table 1302.

Dealer position 1306 enables a dealer or other personnel to facilitate and/or administer the game. In one embodiment, dealer position 1306 includes a table antenna 1308 associated therewith for reading RFID or other suitable tags of chips and/or other game components at or near dealer position 1306.

In one embodiment, table antenna 1308 is configured to output and receive wireless signals optimized to read RFID tags of chips, player reward cards, player identification cards, and/or other game components associated with table 1302. While table antenna 1308 and related components of system 1300 are described as being usable with RFID tags, it should be recognized that table antenna 1308 and related components of system 1300 may alternatively or additionally be configured to read near field communication (NFC) and/or other suitable tags or data of chips, player reward cards, player identification cards, and/or other game components associated with table 1302.

Cards 1310 may include one or more decks or groups of playing cards for blackjack, poker, baccarat, or for other suitable games. In one embodiment, cards 1310 may also include an RFID tag or other suitable tag.

Chip tray 1312 may include a plurality of game tokens or chips 1318 that are representative of different monetary values usable for wagering in the game. Alternatively, any other token or monetary representation may be used for wagering during the game in place of, or in addition to, chips 1310. In one embodiment, a table antenna 1308 is positioned at or near chip tray 1312 to read the RFID tags of chips 1318 within chip tray 1312. It should be recognized that all game token, chips or plaques need not contain RFID chips or tags. For example, higher denomination chips, i.e., $25 and over, may contain RFID chips or tags while other game tokens, chips or plaques under a $25 denomination may not contain RFID chips or tags.

Chips 1318 may be substantially circular and may be formed of plastic, metal, ceramic, and/or other material suitable for use at table games in a casino or other gaming establishment 102, for example. Each chip 1318 may be imprinted with a denomination or other marking that indicates a value of chip 1318. Each chip 1318 may also include a token or chip identifier, such as an RFID tag, embedded or stored within an RFID circuit 1320 coupled to a token or chip antenna 1322. Chip antenna 1322 is configured to receive a signal to read the tag from table antenna 1308 and transmit the signal to RFID circuit 1320. In response to the signal, RFID circuit 1320 retrieves the RFID tag and transmits a signal representative of the tag to chip antenna 1322. In turn, chip antenna 1322 transmits the signal representative of the tag to table antenna 1308.

Dealer terminal 1314 is a computing device 300 that may be communicatively coupled to each table antenna 1308. In one embodiment, dealer terminal 1314 receives the signals representative of the RFID tags from table antennas 1308 and stores data representative of the RFID tags in memory device 306 of terminal 1314. By receiving and tracking the RFID tags of chips 1318 during the play of a game, dealer terminal 1314 may track the wagers entered by the player at each player position 1304 and may track the amount won and lost by each player. Alternatively or additionally, dealer terminal 1314 may transmit the data representative of the RFID tags to another device or system, such as server 1316, to track the amount wagered, won, and lost by each player.

In another embodiment, the dealer or other personnel may manually track the players' wagers or buy-in amounts, wins, and/or losses. In the case of manual tracking, the dealer or other personnel may record each player's buy in amounts using dealer terminal 1314 or another suitable device. Upon the conclusion of the play of the game, the dealer or other personnel may record each player's exiting total chip value generally after the player “colors up”.

Server 1316 is a computing device 300 that is communicatively coupled to dealer terminal 1314 by a wired or a wireless network. In one embodiment, server 1316 is embodied as accounting system 128 or is included within accounting system 128. In one embodiment, server 1316 receives data representative of the RFID tags from dealer terminal 1314 and stores the RFID tag data in memory device 306 of server 1316. Server may also track and store the amount of money wagered, won, and lost by the players at table 1302 using RFID tag data received from dealer terminal 1314. Additionally or alternatively, server 1316 may receive signals from table antennas 1308 representative of the RFID tags of chips 1318 for use in tracking and storing the amount of money wagered, won, and lost by the players.

Server 1316 and/or dealer terminal 1314 may use the RFID tag data to calculate a net win amount of each player based on the amount of money wagered, won, and lost by each player. Server 1316 and/or dealer terminal 1314 may also generate a report with the gross amount won, the gross amount lost, the gross amount wagered, the net win amount, and/or any other suitable data as described above. In one embodiment, report is a W-2G form that is issued to the player by dealer terminal 1314 and/or server 1316, and also reported to the IRS.

While the embodiments have been described herein with respect to reporting winnings of a player at a gaming device 114 within a gaming establishment 102, it should be recognized that the methods and systems described herein may also track and report winnings of the player as the player plays games of chance at multiple gaming devices 114 within one or more gaming establishments 102. It should be recognized the gaming establishments may include traditional gaming establishments or internet based gaming establishments and the like. For example, if the player uses a player reward card or another suitable form of identification as the player plays at multiple gaming devices 114, the player's wagers and winnings may be tracked at each of the gaming devices 114 and may be aggregated by accounting system 128 and/or another suitable system or device.

Similarly, in an embodiment in which accounting system 128 is not limited to being used within one gaming establishment 102, accounting system 128 may track and aggregate the player's wagers and winnings across different gaming establishments 102. In such an embodiment, the player reward card or other suitable identification must be usable and tracked at each gaming establishment 102. Alternatively, accounting system 128 or another suitable system or device may keep a record of different player reward cards or other identifications used by the player across different gaming establishments and may prepare an aggregate report of the wagers and winnings of the player using the various rewards cards or identifications.

The systems, methods, and examples described herein should be viewed as illustrative rather than limiting. For example, while the embodiments described herein generally refer to games of video reel slots, video poker, race or sports betting, table games, bingo, keno, and the like, it should be recognized that the systems and methods described herein may be used with any suitable game of chance. In a similar manner, while the embodiments described herein focus on generating a W-2G form for the IRS, it should be recognized that any suitable report or form may be generated by the embodiments described herein and may be generated by any suitable means and transmitted by any suitable means to the IRS or other regulatory agencies. Additionally, any number and type of house indicia, player indicia, or pay tables may be used with player cards during the game. Player cards, keno boards, and bingo flashboards may be of any suitable size or shape as desired to comply with relevant gaming regulations.

In addition, components of devices or systems described herein may be used in, and/or combined with, other devices or systems described herein unless otherwise specified. Likewise, the functionality of the systems and devices described herein may be used in, combined with, and/or incorporated into other systems and devices described herein unless otherwise specified. For example, two or more of the systems or devices described herein may be combined together, and/or one or more of the systems or devices described herein may be split into two or more other systems or devices.

Unless otherwise specified, “a” or “an” means one or more of a referenced object or step. Furthermore, unless otherwise specified, each method described herein is not limited to the order in which the steps of each method are described or introduced. Rather, the steps may be rearranged in any suitable order, may be omitted, and/or may be combined with steps of other methods as desired. In addition, aspects or components of each embodiment and/or figure described herein may be omitted, or may be combined with, or modified to include, aspects or components of any other embodiment and/or figure unless otherwise specified.

Unless otherwise specified, the phrase “at least one of A and B” means one or more of A alone, one or more of B alone, or one or more of the combination of A and B.

This written description uses examples to describe embodiments of the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a gaming device comprising:
a randomization device configured to randomly select a plurality of house indicia associated with a game of chance;
an input device configured to receive a physical item associated with a monetary value;
a user interface configured to:
enable a player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said gaming device; and
a win meter included within said gaming device or said accounting system, wherein said win meter is configured to output a signal representative of an amount of money or credits won by the player;
wherein said gaming device is further configured to:
require a player to submit identification including at least the player's taxpayer identification number; and
generate a report including the amount of money or credits won by the player upon a determination that a reporting event has occurred.

2. The system of claim 1, wherein the report includes a net win amount of the player.

3. The system of claim 1, wherein the report includes a plurality of individual wins by the player upon a determination that at least one or more of the plurality of wins, either individually or in the aggregate, meets a predetermined reporting threshold.

4. The system of claim 1, wherein the report is a W-2G form that is generated for the player and for submission to the Internal Revenue Service.

5. The system of claim 1, wherein the reporting event includes an elapsing of a predetermined amount of time.

6. The system of claim 1, wherein the reporting event includes a determination that the net win amount is equal to or exceeds a predetermined threshold.

7. The system of claim 1, wherein the reporting event includes a combination of an elapsing of a predetermined amount of time and a determination that the net win amount is equal to or exceeds a predetermined threshold.

8. The system of claim 1, wherein the reporting event includes a determination that the player has initiated a cash out operation.

9. The system of claim 1, wherein the reporting event includes a combination of a determination that the player has initiated a cash out operation and a determination that the net win amount is equal to or exceeds a predetermined threshold.

10. The system of claim 1, wherein the report includes a list of every prize the player has won that is equal to or that exceeds a predetermined threshold.

11. The system of claim 1, wherein the report includes the net win amount minus each prize the player has won that is equal to or that exceeds a predetermined threshold.

12. The system of claim 1, wherein the report includes the player's taxpayer identification number.

13. The system of claim 1, wherein the player's taxpayer identification number is encrypted and included within the report.

14. A system, comprising:
a plurality of gaming devices usable by a respective player, each said gaming device comprising:
a randomization device configured to randomly select a plurality of house indicia associated with a game of chance;
an input device configured to receive a physical item associated with a monetary value;
a user interface configured to:
enable the player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said plurality of gaming devices;
a win meter included within each said gaming device or said accounting system, wherein said win meter is configured to output a signal representative of an amount of money or credits won by the player;
wherein said gaming device is further configured to:
require the player to submit identification including at least the player's taxpayer identification number; and
generate a report including the amount of money or credits won by the player at said plurality of gaming devices played by the player.

15. The system of claim 14, wherein said plurality of gaming devices are positioned within two or more gaming establishments.

16. The system of claim 14, wherein the report includes the player's net win amount at said plurality of gaming devices.

17. The system of claim 14, wherein the report includes a plurality of individual wins by the player upon a determination that at least one or more of the plurality of wins, either individually or in the aggregate, meets a predetermined reporting threshold.

18. The system of claim 14, wherein the report is a W-2G form that is generated for the player and for submission to the Internal Revenue Service.

19. The system of claim 14, wherein the report includes a list of every prize the player has won that is equal to or that exceeds a predetermined threshold.

20. The system of claim 14, wherein the report includes the net win amount minus each prize the player has won that is equal to or that exceeds a predetermined threshold.

21. The system of claim 14, wherein the report is generated upon a determination that a reporting event occurred.

22. The system of claim 21, wherein the reporting event includes an elapsing of a predetermined amount of time.

23. The system of claim 21, wherein the reporting event includes a determination that the net win amount is equal to or exceeds a predetermined threshold.

24. The system of claim 21, wherein the reporting event includes a combination of an elapsing of a predetermined amount of time and a determination that the net win amount is equal to or exceeds a predetermined threshold.

25. The system of claim 21, wherein the reporting event includes a determination that the player has initiated a cash out operation at one of said plurality of gaming devices.

26. The system of claim 21, wherein the reporting event includes a combination of a determination that the player has initiated a cash out operation at one of said plurality of gaming devices and a determination that the net win amount is equal to or exceeds a predetermined threshold.

27. The system of claim 14, wherein the report includes the player's taxpayer identification number.

28. The system of claim 14, wherein the player's taxpayer identification number is encrypted and included within the report.

29. A system comprising:
a gaming device configured to present a game of chance to a player, said gaming device comprising:
a randomization device configured to randomly select a plurality of house indicia associated with the game of chance;
an input device configured to receive a physical item associated with a monetary value;
a user interface configured to:
enable the player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said gaming device; and
a win meter included within said gaming device or said accounting system, said win meter configured to output a signal representative of an amount of money or credits won by the player;
wherein said gaming device is further configured to:
require the player to submit identification including at least the player's taxpayer identification number; and
generate a report including the amount of money or credits won by the player upon a determination that a reporting event has occurred.

30. The system of claim 29, wherein the report includes a net win amount of the player.

31. The system of claim 29, wherein the report includes a plurality of individual wins by the player upon a determination that at least one or more of the plurality of wins, either individually or in the aggregate, meets a predetermined reporting threshold.

32. The system of claim 29, wherein the report is a W-2G form that is generated for the player and for submission to the Internal Revenue Service.

33. The system of claim 29, wherein the reporting event includes an elapsing of a predetermined amount of time.

34. The system of claim 29, wherein the reporting event includes a determination that the net win amount is equal to or exceeds a predetermined threshold.

35. The system of claim 29, wherein the reporting event includes a combination of an elapsing of a predetermined amount of time and a determination that the net win amount is equal to or exceeds a predetermined threshold.

36. The system of claim 29, wherein the reporting event includes a determination that the player has initiated a cash out operation.

37. The system of claim 29, wherein the reporting event includes a combination of a determination that the player has initiated a cash out operation and a determination that the net win amount is equal to or exceeds a predetermined threshold.

38. The system of claim 29, wherein the report includes a list of every prize the player has won that is equal to or that exceeds a predetermined threshold.

39. The system of claim 29, wherein the report includes the net win amount minus each prize the player has won that is equal to or that exceeds a predetermined threshold.

40. The system of claim 29, wherein the report includes the player's taxpayer identification number.

41. The system of claim 29, wherein the player's taxpayer identification number is encrypted and included within the report.

42. A system, comprising:
a plurality of gaming devices usable by a respective player, each said gaming device comprising:
a randomization device configured to randomly select a plurality of house indicia associated with a game of chance;
an input device configured to receive a physical item associated with a monetary value;
a user interface configured to:
enable the player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said plurality of gaming devices;
a win meter included within each said gaming device or said accounting system, wherein said win meter is configured to output a signal representative of an amount of money or credits won by the player;
wherein each said gaming device is further configured to:
require the player to submit identification including at least the player's taxpayer identification number; and
generate a report including the amount of money or credits won by the player at said plurality of gaming devices played by the player.

43. The system of claim 42, wherein said plurality of gaming devices are positioned within two or more gaming establishments.

44. The system of claim 42, wherein the report includes the player's net win amount at said plurality of gaming devices.

45. The system of claim 42, wherein the report includes a plurality of individual wins by the player upon a determination that at least one or more of the plurality of wins, either individually or in the aggregate, meets a predetermined reporting threshold.

46. The system of claim 42, wherein the report is a W-2G form that is generated for the player and for submission to the Internal Revenue Service.

47. The system of claim 42, wherein the report includes a list of every prize the player has won that is equal to or that exceeds a predetermined threshold.

48. The system of claim 42, wherein the report includes the net win amount minus each prize the player has won that is equal to or that exceeds a predetermined threshold.

49. The system of claim 42, wherein the report is generated upon a determination that a reporting event occurred.

50. The system of claim 49, wherein the reporting event includes an elapsing of a predetermined amount of time.

51. The system of claim 49, wherein the reporting event includes a determination that the net win amount is equal to or exceeds a predetermined threshold.

52. The system of claim 49, wherein the reporting event includes a combination of an elapsing of a predetermined amount of time and a determination that the net win amount is equal to or exceeds a predetermined threshold.

53. The system of claim 49, wherein the reporting event includes a determination that the player has initiated a cash out operation at one of said plurality of gaming devices.

54. The system of claim 49, wherein the reporting event includes a combination of a determination that the player has initiated a cash out operation at one of said plurality of gaming devices and a determination that the net win amount is equal to or exceeds a predetermined threshold.

55. The system of claim 42, wherein the report includes the player's taxpayer identification number.

56. The system of claim 42, wherein the player's taxpayer identification number is encrypted and included within the report.

57. A system, comprising:
a gaming device comprising:
a randomization device configured to randomly select a plurality of house indicia associated with a game of chance;
an input device configured to receive a physical item associated with a monetary value;
a user interface configured to:
enable a player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said gaming device; and
a win meter included within said gaming device or said gaming establishment accounting system, wherein said win meter is configured to output a signal representative of an amount of money or credits won by the player;
wherein said gaming device is further configured to:
require the player to submit identification including at least the player's taxpayer identification number; and
generate a report including the amount of money or credits won by the player.

58. The system of claim 57, wherein the report includes a net win amount of the player.

59. The system of claim 57, wherein the report includes a plurality of individual wins by the player upon a determination that at least one or more of the plurality of wins, either individually or in the aggregate, meets a predetermined reporting threshold.

60. The system of claim 57, wherein the report is a W-2G form that is generated for the player and for submission to the Internal Revenue Service.

61. The system of claim 57, wherein the report includes a list of every prize the player has won that is equal to or that exceeds a predetermined threshold.

62. The system of claim 57, wherein the report includes the net win amount minus each prize the player has won that is equal to or that exceeds a predetermined threshold.

63. The system of claim 57, wherein the report includes the player's taxpayer identification number.

64. The system of claim 57, wherein the player's taxpayer identification number is encrypted and included within the report.

65. A system, comprising:
a plurality of gaming devices, each said gaming device comprising:
a randomization device configured to randomly select a plurality of house indicia associated with a game of chance;
an input device configured to receive a physical item associated with a monetary value;
a user interface configured to:
enable a player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said plurality of gaming devices; and
a win meter included within each said gaming device or said gaming establishment accounting system, wherein said win meter is configured to output a signal representative of an amount of money or credits won by the player;
wherein each said gaming device is further configured to:
require the player to submit identification including at least the player's taxpayer identification number; and
generate a report including the amount of money or credits won by the player at said plurality of gaming devices.

66. The system of claim 65, wherein said plurality of gaming devices are positioned within two or more gaming establishments.

67. The system of claim 65, wherein the report includes the player's net win amount at said plurality of gaming devices.

68. The system of claim 65, wherein the report includes a plurality of individual wins by the player upon a determination that at least one or more of the plurality of wins, either individually or in the aggregate, meets a predetermined reporting threshold.

69. The system of claim 65, wherein the report is a W-2G form that is generated for the player and for submission to the Internal Revenue Service.

70. The system of claim 65, wherein the report includes a list of every prize the player has won that is equal to or that exceeds a predetermined threshold.

71. The system of claim 65, wherein the report includes the net win amount minus each prize the player has won that is equal to or that exceeds a predetermined threshold.

72. The system of claim 65, wherein the report is generated upon a determination that a reporting event occurred.

73. The system of claim 72, wherein the reporting event includes an elapsing of a predetermined amount of time.

74. The system of claim 72, wherein the reporting event includes a determination that the net win amount is equal to or exceeds a predetermined threshold.

75. The system of claim 72, wherein the reporting event includes a combination of an elapsing of a predetermined amount of time and a determination that the net win amount is equal to or exceeds a predetermined threshold.

76. The system of claim 72, wherein the reporting event includes a determination that the player has initiated a cash out operation at one of said plurality of gaming devices.

77. The system of claim 72, wherein the reporting event includes a combination of a determination that the player has initiated a cash out operation at one of said plurality of gaming devices and a determination that the net win amount is equal to or exceeds a predetermined threshold.

78. The system of claim 65, wherein the report includes the player's taxpayer identification number.

79. The system of claim 65, wherein the player's taxpayer identification number is encrypted and included within the report.

80. A system comprising:
a gaming device configured to present a game of chance to a player, said gaming device comprising:
a randomization device configured to randomly select a plurality of house indicia associated with a game of chance;
an input device configured to receive a physical item associated with a monetary value;
a user interface configured to:
enable the player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said gaming device; and
a win meter included within said gaming device or said accounting system, said win meter configured to output a signal representative of an amount of money or credits won by the player;
wherein said gaming device is further configured to:
require the player to submit identification including at least the player's taxpayer identification number; and
generate a report including the amount of money or credits won by the player.

81. The system of claim 80, wherein the report includes a net win amount of the player.

82. The system of claim 80, wherein the report includes a plurality of individual wins by the player upon a determination that at least one or more of the plurality of wins, either individually or in the aggregate, meets a predetermined reporting threshold.

83. The system of claim 80, wherein the report is a W-2G form that is generated for the player and for submission to the Internal Revenue Service.

84. The system of claim 80, wherein the report includes a list of every prize the player has won that is equal to or that exceeds a predetermined threshold.

85. The system of claim 80, wherein the report includes the net win amount minus each prize the player has won that is equal to or that exceeds a predetermined threshold.

86. The system of claim 80, wherein the report includes the player's taxpayer identification number.

87. The system of claim 80, wherein the player's taxpayer identification number is encrypted and included within the report.

88. A system, comprising:
a plurality of gaming devices, each said gaming device comprising:
a randomization device configured to randomly select a plurality of house indicia associated with a game of chance;
an input device configured to receive a physical item associated with a monetary value;
a user interface configured to:
enable a player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said plurality of gaming devices; and
a win meter included within each said gaming device or said gaming establishment accounting system, wherein said win meter is configured to output a signal representative of an amount of money or credits won by the player;
wherein each said gaming device is further configured to:
require the player to submit identification including at least the player's taxpayer identification number; and
generate a report including the amount of money or credits won by the player at said plurality of gaming devices.

89. The system of claim 88, wherein the report includes the player's net win amount at said plurality of gaming devices.

90. The system of claim 88, wherein said plurality of gaming devices are positioned within two or more gaming establishments.

91. The system of claim 88, wherein the report includes a plurality of individual wins by the player upon a determination that at least one or more of the plurality of wins, either individually or in the aggregate, meets a predetermined reporting threshold.

92. The system of claim 88, wherein the report is a W-2G form that is generated for the player and for submission to the Internal Revenue Service.

93. The system of claim 88, wherein the report includes a list of every prize the player has won that is equal to or that exceeds a predetermined threshold.

94. The system of claim 88, wherein the report includes the net win amount minus each prize the player has won that is equal to or that exceeds a predetermined threshold.

95. The system of claim 88, wherein the report includes the player's taxpayer identification number.

96. The system of claim 88, wherein the player's taxpayer identification number is encrypted and included within the report.

97. A computing device comprising:
an input device configured to receive a physical item associated with a monetary value;
a user interface configured to:
enable a player to select a wager for a game of chance; and
enable the player to initiate a cash out operation; and
a processor programmed to:
add the monetary value to a credit balance for the player;
deduct the selected wager from the credit balance;
present the game of chance to the player; and
decrease the credit balance in response to the cash out operation;
wherein said computing device is configured to:
require the player to submit identification including at least the player's taxpayer identification number; and
generate a report including an amount of money or credits won by the player in the game of chance.

98. The computing device of claim 97, wherein the report includes a net win amount of the player.

99. The computing device of claim 97, wherein the report includes a plurality of individual wins by the player upon a determination that at least one or more of the plurality of wins, either individually or in the aggregate, meets a predetermined reporting threshold.

100. The computing device of claim 97, wherein the report is a W-2G form that is generated for the player and for submission to the Internal Revenue Service.

101. The computing device of claim 97, wherein the report is generated upon a determination that a reporting event occurred.

102. The computing device of claim 101, wherein the reporting event includes an elapsing of a predetermined amount of time.

103. The computing device of claim 101, wherein the reporting event includes a determination that the net win amount is equal to or exceeds a predetermined threshold.

104. The computing device of claim 101, wherein the reporting event includes a combination of an elapsing of a predetermined amount of time and a determination that the net win amount is equal to or exceeds a predetermined threshold.

105. The computing device of claim 101, wherein the reporting event includes a determination that the player has initiated a cash out operation.

106. The computing device of claim 101, wherein the reporting event includes a combination of a determination that the player has initiated a cash out operation and a determination that the net win amount is equal to or exceeds a predetermined threshold.

107. The computing device of claim 101, wherein the report includes a list of every prize the player has won that is equal to or that exceeds a predetermined threshold.

108. The computing device of claim 101, wherein the report includes the net win amount minus each prize the player has won that is equal to or that exceeds a predetermined threshold.

109. The computing device of claim 101, wherein the report includes the player's taxpayer identification number.

110. The computing device of claim 101, wherein the player's taxpayer identification number is encrypted and included within the report.

111. A system comprising:
a plurality of game tokens, each said game token comprising a token antenna and a token identifier;
a table for receiving said plurality of game tokens;
at least one table antenna integrated within, or coupled to, said table, wherein said at least one table antenna is configured to communicatively couple to each said token antenna to read each said token identifier; and
a computing device configured to:
require the player to submit identification including at least the player's taxpayer identification number;
determine an amount of money or credits won by the player based on said token identifiers; and
generate a report including the amount of money or credits won by the player.

112. The system of claim 111, wherein the report includes a net win amount of the player.

113. The system of claim 111, wherein the report includes a plurality of individual wins by the player upon a determination that at least one or more of the plurality of wins, either individually or in the aggregate, meets a predetermined reporting threshold.

114. The system of claim 111, wherein the report is a W-2G form that is generated for the player and for submission to the Internal Revenue Service.

115. The system of claim 111, wherein the report is generated upon a determination that a reporting event occurred.

116. The system of claim 115, wherein the reporting event includes an elapsing of a predetermined amount of time.

117. The system of claim 115, wherein the reporting event includes a determination that the net win amount is equal to or exceeds a predetermined threshold.

118. The system of claim 115, wherein the reporting event includes a combination of an elapsing of a predetermined amount of time and a determination that the net win amount is equal to or exceeds a predetermined threshold.

119. The system of claim 115, wherein the report includes a list of every prize the player has won that is equal to or that exceeds a predetermined threshold.

120. The system of claim 115, wherein the report includes a net win amount minus each prize the player has won that is equal to or that exceeds a predetermined threshold.

121. The system of claim 111, wherein the report includes the player's taxpayer identification number.

122. The system of claim 111, wherein the player's taxpayer identification number is encrypted and included within the report.

123. A system, comprising:
a gaming device comprising:
a randomization device configured to randomly select a plurality of house indicia associated with a game of chance;
an input device configured to receive a physical item associated with a monetary value;
a user interface configured to:
enable a player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said gaming device; and
a win meter included within said gaming device or said gaming establishment accounting system, wherein said win meter is configured to output a signal representative of an amount of money or credits won by the player;
wherein said accounting system is configured to:
require the player to submit identification including at least the player's taxpayer identification number; and
generate a report including the amount of money or credits won by the player during a predetermined period of time.

124. The system of claim 123, wherein the predetermined period of time is a calendar year.

125. The system of claim 123, wherein the report includes a net win amount of the player during the predetermined period of time.

126. The system of claim 123, wherein the report includes a plurality of individual wins by the player upon a determination that at least one or more of the plurality of wins, either individually or in the aggregate, meets a predetermined reporting threshold.

127. The system of claim 123, wherein the report is a W-2G form that is generated for the player and for submission to the Internal Revenue Service.

128. The system of claim 123, wherein the report includes a list of every prize the player has won that is equal to or that exceeds a predetermined threshold.

129. The system of claim 123, wherein the report includes the net win amount minus each prize the player has won that is equal to or that exceeds a predetermined threshold.

130. The system of claim 123, wherein the report is generated upon a determination that a reporting event occurred.

131. The system of claim 130, wherein the reporting event includes an elapsing of the predetermined amount of time.

132. The system of claim 130, wherein the reporting event includes a determination that the net win amount is equal to or exceeds a predetermined threshold.

133. The system of claim 130, wherein the reporting event includes a combination of an elapsing of the predetermined amount of time and a determination that the net win amount is equal to or exceeds a predetermined threshold.

134. The system of claim 130, wherein the reporting event includes a determination that the player has initiated a cash out operation.

135. The system of claim 130, wherein the reporting event includes a combination of a determination that the player has initiated a cash out operation and a determination that the net win amount is equal to or exceeds a predetermined threshold.

136. The system of claim 123, wherein the report includes the player's taxpayer identification number.

137. The system of claim 123, wherein the player's taxpayer identification number is encrypted and included within the report.

138. A system, comprising:
a plurality of gaming devices, each said gaming device comprising:
a randomization device configured to randomly select a plurality of house indicia associated with a game of chance;
an input device configured to receive a physical item associated with a monetary value;
a user interface configured to:
enable a player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said plurality of gaming devices; and
a win meter included within each said gaming device or said gaming establishment accounting system, wherein said win meter is configured to output a signal representative of an amount of money or credits won by the player;
wherein said accounting system is configured to:
require the player to submit identification including at least the player's taxpayer identification number; and
generate a report including the amount of money or credits won by the player during a predetermined period of time.

139. The system of claim 138, wherein said plurality of gaming devices are positioned within two or more gaming establishments.

140. The system of claim 138, wherein the report includes the player's net win amount at said plurality of gaming devices during the predetermined period of time.

141. The system of claim 138, wherein the report includes a plurality of individual wins by the player upon a determination that at least one or more of the plurality of wins, either individually or in the aggregate, meets a predetermined reporting threshold.

142. The system of claim 138, wherein the report is a W-2G form that is generated for the player and for submission to the Internal Revenue Service.

143. The system of claim 138, wherein the report includes a list of every prize the player has won that is equal to or that exceeds a predetermined threshold.

144. The system of claim 138, wherein the report includes the net win amount minus each prize the player has won that is equal to or that exceeds a predetermined threshold.

145. The system of claim 138, wherein the report is generated upon a determination that a reporting event occurred.

146. The system of claim 145, wherein the reporting event includes an elapsing of the predetermined amount of time.

147. The system of claim 145, wherein the reporting event includes a determination that the net win amount is equal to or exceeds a predetermined threshold.

148. The system of claim 145, wherein the reporting event includes a combination of an elapsing of the predetermined amount of time and a determination that the net win amount is equal to or exceeds a predetermined threshold.

149. The system of claim 145, wherein the reporting event includes a determination that the player has initiated a cash out operation at one of said plurality of gaming devices.

150. The system of claim 145, wherein the reporting event includes a combination of a determination that the player has initiated a cash out operation at one of said plurality of gaming devices and a determination that the net win amount is equal to or exceeds a predetermined threshold.

151. The system of claim 138, wherein the report includes the player's taxpayer identification number.

152. The system of claim 138, wherein the player's taxpayer identification number is encrypted and included within the report.

153. A system comprising:
a computing device comprising:
an input device configured to receive a physical item associated with a monetary value;
a user interface configured to:
enable a player to select a wager for the game of chance; and
enable the player to initiate a cash out operation;
a processor programmed to:
add the monetary value to a credit balance for the player;
deduct the selected wager from the credit balance;
present the game of chance to the player; and
decrease the credit balance in response to the cash out operation;
an accounting system coupled to said computing device;
a win meter included within said computing device or said accounting system, wherein said win meter is configured to output a signal representative of an amount of money or credits won by the player;
wherein said accounting system is configured to:
require the player to submit identification including at least the player's taxpayer identification number; and
generate a report including the amount of money or credits won by the player during a predetermined period of time.

154. The system of claim 153, wherein the report includes a net win amount of the player during the predetermined period of time.

155. The system of claim 153, wherein the report includes a plurality of individual wins by the player upon a determination that at least one or more of the plurality of wins, either individually or in the aggregate, meets a predetermined reporting threshold.

156. The system of claim 153, wherein the report is a W-2G form that is generated for the player and for submission to the Internal Revenue Service.

157. The system of claim 153, wherein the report includes a list of every prize the player has won that is equal to or that exceeds a predetermined threshold.

158. The system of claim 153, wherein the report includes the net win amount minus each prize the player has won that is equal to or that exceeds a predetermined threshold.

159. The system of claim 153, wherein the report is generated upon a determination that a reporting event has occurred.

160. The system of claim 159, wherein the reporting event includes an elapsing of the predetermined amount of time.

161. The system of claim 159, wherein the reporting event includes a determination that the net win amount is equal to or exceeds a predetermined threshold.

162. The system of claim 159, wherein the reporting event includes a combination of an elapsing of the predetermined amount of time and a determination that the net win amount is equal to or exceeds a predetermined threshold.

163. The system of claim 159, wherein the reporting event includes a determination that the player has initiated a cash out operation.

164. The system of claim 159, wherein the reporting event includes a combination of a determination that the player has initiated a cash out operation and a determination that the net win amount is equal to or exceeds a predetermined threshold.

165. The system of claim 153, wherein the report includes the player's taxpayer identification number.

166. The system of claim 153, wherein the player's taxpayer identification number is encrypted and included within the report.

167. A system comprising:
a plurality of game tokens, each said game token comprising a token antenna and a token identifier;
a table for receiving said plurality of game tokens;
at least one table antenna integrated within, or coupled to, said table, wherein said at least one table antenna is configured to communicatively couple to each said token antenna to read each said token identifier; and
a computing device configured to:
require the player to submit identification including at least the player's taxpayer identification number;
determine an amount of money or credits won by the player during a predetermined period of time based on said token identifiers; and
generate a report including the amount of money or credits won by the player during the predetermined period of time.

168. The system of claim 167, wherein the report includes a net win amount of the player during the predetermined period of time.

169. The system of claim 167, wherein the report includes a plurality of individual wins by the player upon a determination that at least one or more of the plurality of wins, either individually or in the aggregate, meets a predetermined reporting threshold.

170. The system of claim 167, wherein the report is a W-2G form that is generated for the player and for submission to the Internal Revenue Service.

171. The system of claim 167, wherein the report is generated upon a determination that a reporting event occurred.

172. The system of claim 171, wherein the reporting event includes an elapsing of the predetermined amount of time.

173. The system of claim 171, wherein the reporting event includes a determination that the net win amount is equal to or exceeds a predetermined threshold.

174. The system of claim 171, wherein the reporting event includes a combination of an elapsing of the predetermined amount of time and a determination that the net win amount is equal to or exceeds a predetermined threshold.

175. The system of claim 171, wherein the report includes a list of every prize the player has won that is equal to or that exceeds a predetermined threshold.

176. The system of claim 171, wherein the report includes a net win amount minus each prize the player has won that is equal to or that exceeds a predetermined threshold.

177. The system of claim 167, wherein the report includes the player's taxpayer identification number.

178. The system of claim 167, wherein the player's taxpayer identification number is encrypted and included within the report.
